(19) United States
(12) Patent Application Publication
(10) Pub. No.: US 2025/0274708 A1
(43) Pub. Date: Aug. 28, 2025

(54) VEHICULAR APPARATUS

(71) Applicant: LG Display Co., Ltd., Seoul (KR)

(72) Inventors: Seunghyun SUNG, Paju-si (KR); SeungRyull PARK, Paju-si (KR); YuSeon KHO, Paju-si (KR)

(73) Assignee: LG Display Co., Ltd., Seoul (KR)

(21) Appl. No.: 19/064,405

(22) Filed: Feb. 26, 2025

(30) Foreign Application Priority Data
Feb. 27, 2024 (KR) 10-2024-0028011

(51) Int. Cl. H04R 3/12; G09G 3/32; G10K 11/178; H04R 1/02; H04R 1/40; H04R 17/00

(52) U.S. Cl. CPC H04R 3/12; G09G 3/32; G10K 11/17823; G10K 11/17873; H04R 1/025; H04R 1/403; H04R 17/00; G09G 2300/0842; G09G 2300/0861; G09G 2320/068; G09G 2380/10; G10K 2210/1282; G10K 2210/3027; G10K 2210/3215; H04R 2499/13

(57) ABSTRACT

An example of a vehicular apparatus includes a first speaker configured to output a first sound to a periphery of a driver seat based on a first sound signal, a second speaker configured to output a second sound to the periphery of the driver seat based on a second sound signal, and a speaker driving circuit configured to generate the first sound signal and the second sound signal based on a sound source. The second sound signal has an anti-phase opposite to a phase of the first sound signal.

### CROSS-REFERENCE TO RELATED APPLICATIONS

This application claims priority to Korean Patent Application No. 10-2024-0028011 filed on Feb. 27, 2024, the entirety of which is hereby expressly incorporated by reference into the present application.

### BACKGROUND

### Technical Field

The present disclosure relates to a vehicular apparatus.

### Description of the Related Art

Vehicular apparatuses (or vehicles) include a speaker (or sound apparatus) which outputs a sound based on an audio signal output from a multimedia device such as a car audio device or the like. For example, the speaker applied to vehicles can include a front speaker and a rear speaker, which are configured as a coil type.

### SUMMARY OF THE DISCLOSURE

One or more display apparatuses for providing desired information or content to a driver or a passenger can be equipped in a vehicular apparatus. An entertainment image or a media image displayed by a display apparatus equipped in a vehicular apparatus and a sound corresponding thereto can interrupt the safe driving of a driver.

The inventors of the present application have recognized the problems or other limitations described above and have performed various research and experiments for implementing a vehicular apparatus which can block an image and a sound interrupting the safe driving of a driver. Based on the various research and experiments, the inventors have invented a vehicular apparatus which can block an image and a sound interrupting the safe driving of a driver.

An aspect of the present disclosure is directed to providing a vehicular apparatus which can block a sound interrupting the safe driving of a driver.

Another aspect of the present disclosure is directed to providing a vehicular apparatus which can block an image and a sound interrupting the safe driving of a driver.

Another aspect of the present disclosure is directed to providing a vehicular apparatus which can block an image and a sound interrupting the safe driving of a driver while providing a driving information image and a driving information sound to the driver.

Another aspect of the present disclosure is directed to providing a vehicular apparatus which can provide an entertainment image and sound to only a passenger other than a driver.

Another aspect of the present disclosure is directed to providing a vehicular apparatus which can provide an entertainment sound to only a passenger sitting on a passenger seat.

Additional features, advantages, and aspects will be set forth in the description that follows, and in part will be apparent from the description, or can be learned by practice of the inventive concepts provided herein. Other features, advantages, and aspects of the present disclosure can be realized and attained by the structure particularly pointed out in the written description, or derivable therefrom, and the claims hereof as well as the appended drawings.

To achieve these and other advantages and aspects of the present disclosure, as embodied and broadly described herein, in one or more aspects, a vehicular apparatus includes a first speaker configured to output a first sound to a periphery of a driver seat based on a first sound signal, a second speaker configured to output a second sound to the periphery of the driver seat based on a second sound signal, and a speaker driving circuit configured to generate the first sound signal and the second sound signal based on a sound source. The second sound signal has an anti-phase opposite to a phase of the first sound signal.

Details of other embodiments of the present disclosure will be included in the detailed description of the disclosure and the accompanying drawings.

The vehicular apparatus according to one or more embodiments of the present disclosure can block a sound interrupting the safe driving of a driver.

The vehicular apparatus according to one or more embodiments of the present disclosure can block an image and a sound interrupting the safe driving of a driver.

The vehicular apparatus according to one or more embodiments of the present disclosure can block an image and a sound interrupting the safe driving of a driver while providing a driving information image and a driving information sound to the driver.

The vehicular apparatus according to one or more embodiments of the present disclosure can provide an entertainment image and sound to only a passenger other than a driver.

The vehicular apparatus according to one or more embodiments of the present disclosure can provide an entertainment sound to only a passenger sitting on a passenger seat.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure and together with the description serve to explain principles of the disclosure.

FIG. 1 illustrates a vehicular apparatus according to an embodiment of the present disclosure.

FIG. 2 illustrates an arrangement structure of a directional speaker in a vehicular apparatus according to an embodiment of the present disclosure.

FIG. 3 illustrates a vehicular apparatus according to another embodiment of the present disclosure.

FIG. 4 illustrates a speaker driving circuit according to an embodiment of the present disclosure.

FIG. 5 illustrates a vehicular apparatus according to another embodiment of the present disclosure.

FIG. 6 illustrates a display apparatus according to an embodiment of the present disclosure illustrated in FIG. 5.

FIG. 7 is an equivalent circuit view illustrating a circuit configuration of each of a plurality of subpixels according to an embodiment of the present disclosure illustrated in FIG. 6.

FIG. 8 illustrates a circuit for a sound output of a vehicular apparatus according to another embodiment of the present disclosure.

FIG. 9 illustrates a sound output system of a vehicular apparatus according to another embodiment of the present disclosure.

FIG. 10 illustrates a sound output system of a vehicular apparatus according to another embodiment of the present disclosure.

FIG. 11 illustrates a sound output system of a vehicular apparatus according to another embodiment of the present disclosure.

FIG. 12 illustrates a sound output system of a vehicular apparatus according to another embodiment of the present disclosure.

FIG. 13 illustrates a sound output system of a vehicular apparatus according to another embodiment of the present disclosure.

FIG. 14 is a schematic diagram of an experimental example for measuring a sound canceling effect of a vehicular apparatus according to an embodiment of the present disclosure.

FIG. 15 illustrates a frequency-based sound pressure level according to an experimental example of the present disclosure illustrated in FIG. 14.

FIG. 16 illustrates a frequency-based sound pressure level according to an experimental example of the present disclosure illustrated in FIG. 14.

FIG. 17 illustrates a frequency-based sound pressure level according to an experimental example of the present disclosure illustrated in FIG. 14.

FIG. 18 illustrates a frequency-based sound pressure level according to an experimental example of the present disclosure illustrated in FIG. 14.

FIG. 19 illustrates a frequency-based sound pressure level according to an experimental example of the present disclosure illustrated in FIG. 14.

FIG. 20 is a schematic diagram of another experimental example for measuring a sound canceling effect of a vehicular apparatus according to an embodiment of the present disclosure.

FIG. 21 illustrates a frequency-based sound pressure level according to another experimental example of the present disclosure illustrated in FIG. 20.

FIG. 22 is a schematic diagram of another experimental example for measuring a sound canceling effect of a vehicular apparatus according to an embodiment of the present disclosure.

FIG. 23 illustrates a frequency-based sound pressure level according to another experimental example of the present disclosure illustrated in FIG. 22.

Throughout the drawings and the detailed description, unless otherwise described, the same drawing reference numerals should be understood to refer to the same elements, features, and structures. The sizes, lengths, and thicknesses of layers, regions and elements, and depiction of thereof can be exaggerated for clarity, illustration, and convenience.

### DETAILED DESCRIPTION OF THE EMBODIMENTS

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure can be thorough and complete to assist those skilled in the art to understand the inventive concepts without limiting the protected scope of the present disclosure.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description.

In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms. These terms are only used to distinguish one element from another and may not define order or sequence. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” or the like can be used. These terms are intended to identify the corresponding element(s) from the other element(s), and these are not used to define the essence, basis, order, or number of the elements.

For the expression that an element is “connected,” “coupled,” or “contact,” to another element, the element may not only be directly connected, coupled, or contacted to another element, but also be indirectly connected, coupled, or contacted to another element with one or more intervening elements interposed between the elements, unless otherwise specified.

For the expression that an element is “contacts” or “overlaps” with another element, the element can not only directly contact, overlap, or the like with another element, but also indirectly contact or overlap with another element with one or more intervening elements disposed or interposed between the elements, unless otherwise specified.

The term “at least one” should be understood as including any and all combinations of one or more of the associated listed items. For example, the meaning of “at least one of a first item, a second item and a third item” denotes the combination of all items proposed from two or more of the first item, the second item and the third item as well as the first item, the second item or the third item. Further, the term “can” fully encompasses all the meanings and coverages of the term “may” and vice versa.

Here, “X-axis direction”, “Y-axis direction”, and “Z-axis direction” should not be construed by a geometric relation only of a mutual vertical relation and can have broader directionality within the range that elements of the present disclosure can act functionally.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, example embodiments of a light emitting display apparatus according to the present disclosure will be described in detail with reference to the accompanying drawings. All the components of each light emitting display apparatus according to all embodiments of the present disclosure are operatively coupled and configured. For convenience of description, a scale of each of elements illustrated in the accompanying drawings differs from a real scale, and thus, is not limited to a scale illustrated in the drawings.

FIG. 1 illustrates a vehicular apparatus according to an embodiment of the present disclosure. For example, FIG. 1 illustrates a vehicular apparatus or a sound system for a vehicular apparatus according to an embodiment of the present disclosure.

Referring to FIG. 1, the vehicular apparatus (or the sound system for the vehicular apparatus) according to an embodiment of the present disclosure can include a driver seat 11, a first speaker 110, and a second speaker 120.

The driver seat 11 can be a seat for a driver of a vehicular apparatus (or a vehicle). The driver seat 11 can be configured to face a handle 10 of the vehicular apparatus. The driver seat 11 can include a seat cushion 11a, a seatback 11b connected to the seat cushion 11a, and a headrest 11c connected to an upper portion of the seatback 11b.

The first speaker 110 can be at a periphery of the driver seat 11. The first speaker 110 can be configured to output (or provide) a first sound to the periphery of the driver seat 11.

The first speaker 110 according to an embodiment of the present disclosure can be configured to output the first sound to a driver 1 from behind the driver 1. For example, the first sound can include sound information which interrupts the safe driving of the driver 1 or can interrupt the safe driving of the driver 1. For example, the first sound can be an original sound, a main sound, an entertainment sound, a media sound, a multimedia sound, a moving image sound, or a moving image content sound, but embodiments of the present disclosure are not limited thereto. For example, the first speaker 110 can be a speaker, a front speaker, a first front speaker, a left speaker, a first left speaker, a normal speaker, or a first normal speaker, but embodiments of the present disclosure are not limited thereto.

The first speaker 110 can be configured in the driver seat 11. For example, the first speaker 110 can be configured in a headrest 11c of the driver seat 11. For example, the first speaker 110 can be accommodated (or configured) in an inner portion of a headrest 11c of the driver seat 11. For example, the first speaker 110 can be configured to output the first sound toward ears of the driver 1 from behind the driver 1. Accordingly, the driver 1 can listen to the first sound output from the first speaker 110 behind the driver 1. For example, a distance D1 between the first speaker 110 and the ears of the driver 1 can be 5 cm or more and 10 cm or less, but embodiments of the present disclosure are not limited thereto.

According to an embodiment of the present disclosure, the first speaker 110 can be configured at one or more of a first edge portion and a second edge portion of the headrest 11c, but embodiments of the present disclosure are not limited thereto. For example, with respect to a width direction Y of the vehicular apparatus, the headrest 11c of the driver seat 11 can include a left portion and a right portion.

For example, the first speaker 110 can be configured at one or more of the left portion and the right portion of the headrest 11c of the driver seat 11.

The first speaker 110 according to an embodiment of the present disclosure can be driven (or vibrated or displaced) according to a first sound signal based on a sound source to output the first sound. For example, the first sound signal can be a signal which is modulated and amplified from the sound source. For example, the first sound signal can be a sound signal, an original sound signal, an in-phase original sound signal, a sound driving signal, a normal driving signal, an in-phase sound signal, or an in-phase driving signal, but embodiments of the present disclosure are not limited thereto.

The first speaker 110 according to an embodiment of the present disclosure can include one or more sound apparatuses 111 and 112. The one or more sound apparatuses 111 and 112 can be configured in the headrest 11c of the driver seat 11 and can be configured to output the first sound toward the ears of the driver 1. For example, the one or more sound apparatuses (for example, first and second sound apparatuses) 111 and 112 can be driven based on the first sound signal to output the first sound.

The first speaker 110 according to an embodiment of the present disclosure can include a first sound apparatus 111 and a second sound apparatus 112. For example, the first sound apparatus 111 can be configured at the first edge portion (or a left portion) of the headrest 11c of the driver seat 11 and can be configured to output the first sound toward a left ear of the driver 1. The second sound apparatus 112 can be configured at the second edge portion (or a right portion) of the headrest 11c of the driver seat 11 and can be configured to output the first sound toward a right ear of the driver 1. For example, the first sound apparatus 111 and the second sound apparatus 112 can be driven based on a same first sound signal to output a same first sound.

According to an embodiment of the present disclosure, a distance D1 between each of the first sound apparatus 111 and the second sound apparatus 112 and the ears of the driver 1 can be 5 cm or more and 10 cm or less, but embodiments of the present disclosure are not limited thereto.

The first speaker 110 (or the first sound apparatus 111 and the second sound apparatus 112) according to an embodiment of the present disclosure can include a vibration plate (or a self-vibration plate) and can vibrate the vibration plate according to the first sound signal to output the first sound, but embodiments of the present disclosure are not limited thereto. For example, the first speaker 110 (or the first sound apparatus 111 and the second sound apparatus 112) can use, as a vibration plate, a headrest interior material surrounding the headrest 11c and can vibrate (or directly vibrate) the headrest interior material according to the first sound signal to output the first sound.

According to an embodiment of the present disclosure, the first speaker 110 (or the first sound apparatus 111 and the second sound apparatus 112) can include a coil-type sound apparatus having a magnet and a coil. For example, the coil-type sound apparatus can be configured to vibrate (or driven) based on the first sound signal to output (or generate) the first sound, based on Fleming's left hand rule. For example, the coil-type sound apparatus can be an actuator, a coil-type actuator, a transducer, an exciter, or a coil-type exciter, but embodiments of the present disclosure are not limited thereto.

According to another embodiment of the present disclosure, the first speaker 110 (or the first sound apparatus 111 and the second sound apparatus 112) can include a piezoelectric-type sound apparatus having a piezoelectric material. For example, the piezoelectric-type sound apparatus can be configured to vibrate (or driven) by a piezoelectric effect based on the first sound signal to output (or generate) the first sound. For example, the piezoelectric-type sound apparatus can be a piezoelectric film, a vibration film, a film transducer, a film actuator, or a film exciter, but embodiments of the present disclosure are not limited thereto.

The second speaker 120 can be at the periphery of the driver seat 11. The second speaker 120 can be at a periphery of the first speaker 110. The second speaker 120 can be configured to output (or provide) a second sound to the periphery of the driver seat 11. For example, the second speaker 120 can be configured to output (or provide) the second sound for attenuating (or offsetting or blocking) the first sound transferred (or output) from the first speaker 110 to the driver 1. For example, the second sound can have a same sound source as the first sound output from the first speaker 110 and can have an anti-phase with respect to the first sound. For example, the second sound can be an auxiliary sound, an original sound attenuation sound, an original sound offset sound, a source sound blocking sound, an original sound canceling sound, or an anti-phase sound, but embodiments of the present disclosure are not limited thereto. For example, the second speaker 120 can be an auxiliary speaker, a front auxiliary speaker, a sound attenuation speaker, a sound offset speaker, a sound blocking speaker, an original sound blocking speaker, a sound canceling speaker, or an anti-phase speaker, but embodiments of the present disclosure are not limited thereto.

The second speaker 120 according to an embodiment of the present disclosure can be disposed (or configured) adjacent to the first speaker 110. The second speaker 120 can be configured in the driver seat 11 so as to be adjacent to the first speaker 110. The second speaker 120 can be configured in the headrest 11c of the driver seat 11 adjacent to the first speaker 110. For example, the second speaker 120 can be accommodated (or configured) in the inner portion of the headrest 11c of the driver seat 11 adjacent to the first speaker 110. For example, the second speaker 120 can be configured to output the second sound toward an ear of the driver 1 from behind the driver 1. For example, the second speaker 120 can be configured at one or more of the first edge portion (or the left portion) and the second edge portion (or the right portion) of the headrest 11c of the driver seat 11 adjacent to the first speaker 110, but embodiments of the present disclosure are not limited thereto.

The second speaker 120 according to an embodiment of the present disclosure can be driven (or vibrated or displaced) according to a second sound signal based on the sound source to output the second sound. For example, the second sound signal can be a phase modulation and amplified signal of the sound source. For example, the second sound signal can be an anti-phase modulation and amplified signal of the sound source for attenuating (or offsetting or blocking) the first sound transferred to the driver 1. For example, the second sound signal can be an original sound modulation signal, an original sound phase modulation signal, an original sound anti-phase modulation signal, an anti-phase sound signal, an auxiliary sound signal, an auxiliary speaker driving signal, an anti-phase driving signal, or a sound canceling signal, but embodiments of the present disclosure are not limited thereto.

According to an embodiment of the present disclosure, a distance D1 between the second speaker 120 and the ears of the driver 1 can be 5 cm or more and 10 cm or less, but embodiments of the present disclosure are not limited thereto. For example, distances D1 between each of the first speaker 110 and the second speaker 120 and the driver 1 can be equal to each other. For example, a sound output direction of the first speaker 110 can differ from that of the second speaker 120. For example, an angle between the first speaker 110 and the second speaker 120 can be 0 degrees or more and 60 degrees or less, but embodiments of the present disclosure are not limited thereto. For example, an angle between the sound output direction of the first speaker 110 and the sound output direction of the second speaker 120 can be 0 degrees or more and 60 degrees or less, but embodiments of the present disclosure are not limited thereto.

The second speaker 120 according to an embodiment of the present disclosure can include one or more auxiliary sound apparatuses 121 and 122. The one or more auxiliary sound apparatuses 121 and 122 can be disposed in parallel with the one or more sound apparatuses 111 and 112. The one or more auxiliary sound apparatuses 121 and 122 can be configured in the headrest 11c of the driver seat 11 in parallel with the one or more sound apparatuses 111 and 112 and can be configured to output the second sound toward the ears of the driver 1. For example, the one or more auxiliary sound apparatuses 121 and 122 can be driven based on the second sound signal to output the second sound. For example, the one or more auxiliary sound apparatuses 121 and 122 can be a sound apparatus, a speaker apparatus, a sound output apparatus, a canceling sound apparatus, or a canceling sound output apparatus, but embodiments of the present disclosure are not limited thereto.

The second speaker 120 according to an embodiment of the present disclosure can include a first auxiliary sound apparatus (or a third sound apparatus) 121 and a second auxiliary sound apparatus (or a fourth sound apparatus) 122. The first auxiliary sound apparatus 121 can be configured in the first edge portion (or the left portion) of the headrest 11c of the driver seat 11 in parallel with the first sound apparatus 111 of the first speaker 110 and can be configured to output the second sound toward the left ear of the driver 1. The second auxiliary sound apparatus 122 can be configured in the second edge portion (or the right portion) of the headrest 11c of the driver seat 11 in parallel with the second sound apparatus 112 and can be configured to output the second sound toward the right ear of the driver 1. For example, the first auxiliary sound apparatus 121 and the second auxiliary sound apparatus 122 can be configured to output a same second sound. For example, the first auxiliary sound apparatus 121 and the second auxiliary sound apparatus 122 can be driven based on a same first sound signal to output the same second sound.

The second speaker 120 (or the first auxiliary sound apparatus 121 and the second auxiliary sound apparatus 122) according to an embodiment of the present disclosure can include a vibration plate (or a self-vibration plate) and can vibrate the vibration plate according to the first sound signal to output the second sound, but embodiments of the present disclosure are not limited thereto. For example, the second speaker 120 (or the first auxiliary sound apparatus 121 and the second auxiliary sound apparatus 122) can use, as a vibration plate, the headrest interior material surrounding the headrest 11c and can vibrate (or directly vibrate) the headrest interior material according to the first sound signal to output the second sound.

According to an embodiment of the present disclosure, the second speaker 120 (or the first auxiliary sound apparatus 121 and the second auxiliary sound apparatus 122) can be configured to have the same sound characteristic or sound output characteristic as that of the first speaker 110 (or the first sound apparatus 111 and the second sound apparatus 112), so as to maximize a canceling effect of the first sound. For example, the second speaker 120 (or the first auxiliary sound apparatus 121 and the second auxiliary sound apparatus 122) can include a same coil-type sound apparatus or piezoelectric-type sound apparatus as the first speaker 110 (or the first sound apparatus 111 and the second sound apparatus 112), but embodiments of the present disclosure are not limited thereto. For example, the second speaker 120 (or the first auxiliary sound apparatus 121 and the second auxiliary sound apparatus 122) can be configured with the same sound apparatus as the first speaker 110 (or the first sound apparatus 111 and the second sound apparatus 112) of the coil-type sound apparatus and the piezoelectric-type sound apparatus.

According to an embodiment of the present disclosure, a distance D1 between each of the first auxiliary sound apparatus 121 and the second auxiliary sound apparatus 122 and the ears of the driver 1 can be 5 cm or more and 10 cm or less, but embodiments of the present disclosure are not limited thereto.

According to an embodiment of the present disclosure, the distance D1 between the first sound apparatus 111 and the driver 1 can be a same as the distance D1 between the first auxiliary sound apparatus 121 and the driver 1. The distance D1 between the second sound apparatus 112 and the driver 1 can be a same as the distance D1 between the second auxiliary sound apparatus 122 and the driver 1. For example, an angle between the first sound apparatus 111 and the first auxiliary sound apparatus 121 can be 0 degrees or more and 60 degrees or less, but embodiments of the present disclosure are not limited thereto. For example, an angle between the sound output direction of the first sound apparatus 111 and the sound output direction of the first auxiliary sound apparatus 121 can be 0 degrees or more and 60 degrees or less, but embodiments of the present disclosure are not limited thereto. For example, an angle between the second sound apparatus 112 and the second auxiliary sound apparatus 122 can be 0 degrees or more and 60 degrees or less, but embodiments of the present disclosure are not limited thereto. For example, an angle between the sound output direction of the second sound apparatus 112 and the sound output direction of the second auxiliary sound apparatus 122 can be 0 degrees or more and 60 degrees or less, but embodiments of the present disclosure are not limited thereto.

The vehicular apparatus (or the sound system for the vehicular apparatus) according to an embodiment of the present disclosure can further include a directional speaker 190.

The directional speaker 190 can be at a periphery of the driver seat 11. The directional speaker 190 can be configured to output a third sound having directivity to the driver seat 11. The directional speaker 190 can be configured to output (or provide) the third sound corresponding to driving information to the driver 1, at the periphery of the driver seat 11. For example, the directional speaker 190 can be configured to output (or provide) the third sound toward the ear of the driver 1, at a periphery of the driver seat 11. For example, the directional speaker 190 can be configured to output (or provide) the third sound toward one or more of the left ear and the right ear of the driver 1, at the periphery of the driver seat 11. For example, the third sound can include driving information about the vehicular apparatus, but embodiments of the present disclosure are not limited thereto. For example, the driving information can include navigation information including a driving path and safe driving information, or the like, but embodiments of the present disclosure are not limited thereto. For example, the third sound can be a directional sound, a driving information sound, a navigation sound, a safe driving information sound, or an alarm sound, but embodiments of the present disclosure are not limited thereto.

The directional speaker 190 according to an embodiment of the present disclosure can be driven (or vibrated or displaced) by a third sound signal based on the driving information to output the third sound having directivity. For example, the third sound signal can include a carrier signal where an amplitude has been modulated, but embodiments of the present disclosure are not limited thereto. For example, the third sound signal can be generated by the amplitude modulation of the carrier signal and a driving information sound signal corresponding to the driving information. For example, the third sound signal can be generated by the amplitude modulation of the carrier signal, based on the driving information sound signal corresponding to the driving information. For example, the carrier signal can be an ultrasound signal or an ultrasound carrier signal, but embodiments of the present disclosure are not limited thereto. For example, the third sound signal or the carrier signal can have a frequency of 20 kHz or more, but embodiments of the present disclosure are not limited thereto. For example, the third sound signal or the carrier signal can have a frequency of 40 kHz or more, but embodiments of the present disclosure are not limited thereto. The third sound according to an embodiment of the present disclosure can have directivity, based on the carrier signal having a frequency of 20 kHz or more, and thus, can be transferred to only the driver 1.

The directional speaker 190 according to an embodiment of the present disclosure can include the piezoelectric-type sound apparatus including the piezoelectric material, but embodiments of the present disclosure are not limited thereto. The directional speaker 190 can vibrate (or displace) based on the piezoelectric effect based on the third sound signal to output the third sound. For example, the directional speaker 190 can be a directional piezoelectric film, a directional vibration film, a directional film actuator, or a directional film exciter, but embodiments of the present disclosure are not limited thereto.

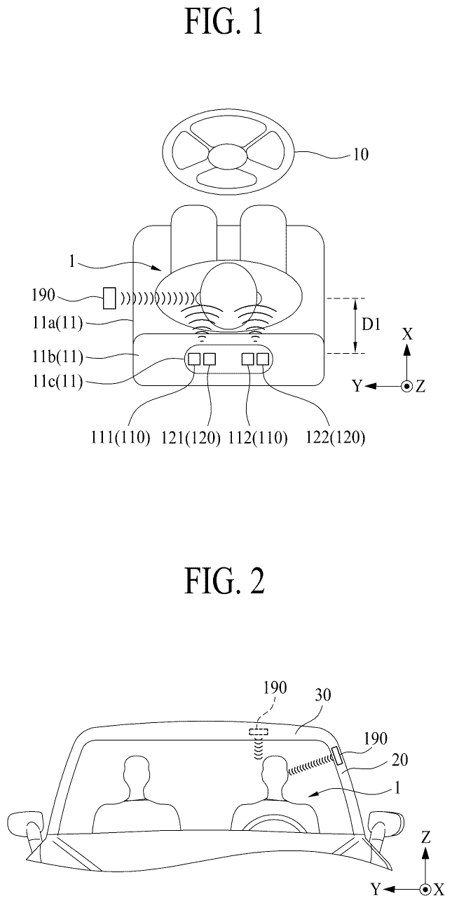

The directional speaker 190 according to an embodiment of the present disclosure, as illustrated in FIG. 2, can be configured in a pillar interior material 20 at a periphery of a driver seat window at one side of the driver seat 11. For example, the directional speaker 190 can be configured to output the third sound having directivity toward the ears of the driver 1 from the pillar interior material 20. For example, the directional speaker 190 can be disposed (or configured) between the pillar interior material 20 and a pillar structure (or a pillar frame) and can self-vibrate (or displace) based on the piezoelectric effect based on the third sound signal to output the third sound, but embodiments of the present disclosure are not limited thereto. For example, the directional speaker 190 can be connected (or attached) to the pillar interior material 20, can use the pillar interior material 20 as a vibration plate, and can vibrate (or directly vibrate) the pillar interior material 20, based on the piezoelectric effect based on the third sound signal, to output the third signal.

The directional speaker 190 according to an embodiment of the present disclosure, as illustrated in FIG. 2, can be configured in a roof interior material 300 on the driver seat 11 with respect to a height direction Z of the vehicular apparatus. For example, the directional speaker 190 can be configured to output the third sound having directivity toward the ears of the driver 1 from the roof interior material 300. For example, the directional speaker 190 can be disposed (or configured) between the roof interior material 300 and a roof structure (or a roof panel) and can self-vibrate (or displace) based on the piezoelectric effect based on the third sound signal to output the third sound, but embodiments of the present disclosure are not limited thereto. For example, the directional speaker 190 can be connected (or attached) to the roof interior material 300, can use the roof interior material 300 as a vibration plate, and can vibrate (or directly vibrate) the roof interior material 300, based on the piezoelectric effect based on the third sound signal, to output the third signal.

The vehicular apparatus (or the sound system for the vehicular apparatus) according to an embodiment of the present disclosure can attenuate (or offset or block) the first sound transferred from the first speaker 110 to the driver 1 by using the second sound output from the second speaker 120, and thus, can minimize or prevent disturbance of the safe driving of the driver 1 caused by the first sound output from the first speaker 110. In addition, the vehicular apparatus (or the sound system for the vehicular apparatus) according to an embodiment of the present disclosure can further output the third sound having directivity through the directional speaker 190, and thus, can transfer (or provide) driving information to only the driver 1 through the third sound. Furthermore, the vehicular apparatus (or the sound system for the vehicular apparatus) according to an embodiment of the present disclosure can block the first sound transferred to the driver 1 through destructive interference between an in-phase first sound and an anti-phase second sound corresponding to the same source sound and can transfer the driving information to only the driver 1 through the third sound having directivity.

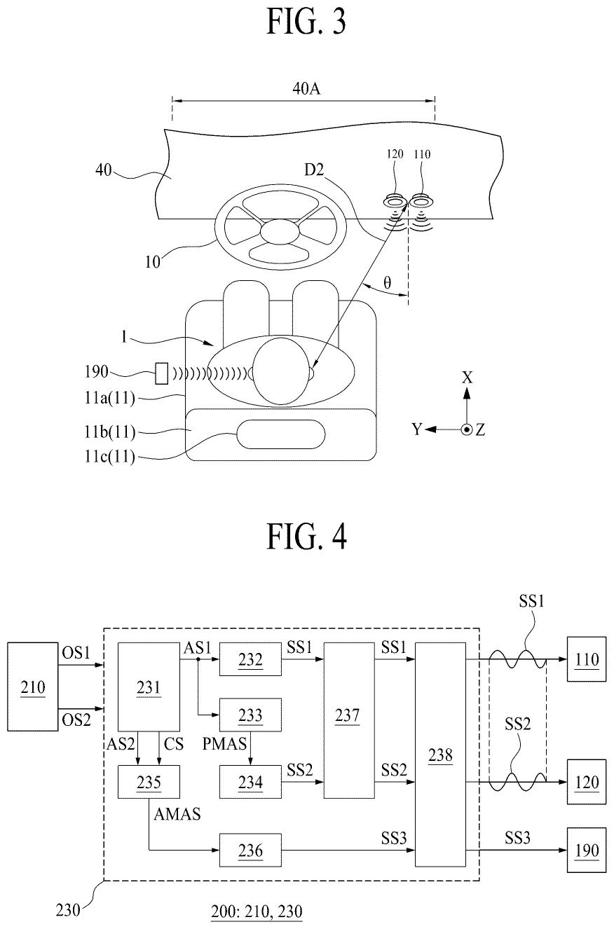

FIG. 3 illustrates a vehicular apparatus according to another embodiment of the present disclosure. For example, FIG. 3 illustrates a vehicular apparatus or a sound system for a vehicular apparatus according to another embodiment of the present disclosure.

Referring to FIG. 3, the vehicular apparatus (or the sound system for the vehicular apparatus) according to another embodiment of the present disclosure can include a driver seat 11, a first speaker 110, and a second speaker 120.

The driver seat 11 can be configured to face a handle 10 of the vehicular apparatus. The driver seat 11 can include a seat cushion 11a, a seatback 11b connected to the seat cushion 11a, and a headrest 11c connected to an upper portion of the seatback 11b.

The first speaker 110 according to another embodiment of the present disclosure can be in front of the driver seat 11. The first speaker 110 can be configured to output a first sound to a driver 1 in the front of the driver 1. For example, the first speaker 110 can be configured to output the first sound toward ears of the driver 1 in the front of the driver 1.

A distance D2 between the first speaker 110 and the driver 1 according to another embodiment of the present disclosure can be 30 cm or less, but embodiments of the present disclosure are not limited thereto. For example, the distance D2 between the first speaker 110 and the ears of the driver 1 can be 30 cm or less, but embodiments of the present disclosure are not limited thereto.

An angle (θ) between the first speaker 110 and the driver 1 according to another embodiment of the present disclosure can be 30 degrees or more and less than 90 degrees, but embodiments of the present disclosure are not limited thereto. For example, an angle between a sound output direction of the first speaker 110 and the ears of the driver 1 can be 30 degrees or more and less than 90 degrees, but embodiments of the present disclosure are not limited thereto.

The first speaker 110 according to another embodiment of the present disclosure can be configured in a dashboard 40. For example, the first speaker 110 can be configured in a driver seat region (or a front left region or driver's seat region) 40A of the dashboard 40. For example, with respect to a width direction Y of the vehicular apparatus, the first speaker 110 can be configured at one lateral portion of the driver seat region 40A of the dashboard 40 adjacent to a center portion of the dashboard 40, but embodiments of the present disclosure are not limited thereto. For example, the first speaker 110 can be configured at any one of a first edge portion and a second edge portion of the driver seat region 40A of the dashboard 40, but embodiments of the present disclosure are not limited thereto. For example, with respect to the width direction Y of the vehicular apparatus, the first speaker 110 can be configured at any one of a left portion and a right portion of the driver seat region 40A of the dashboard 40, but embodiments of the present disclosure are not limited thereto.

The first speaker 110 according to an embodiment of the present disclosure can be driven (or vibrated or displaced) according to a first sound signal based on a sound source to output the first sound. For example, except for that the first speaker 110 is disposed (or configured) in the dashboard 40, the first speaker 110 can be a same or substantially a same as that of the first speaker 110 described above with reference to FIG. 1, and thus, like reference numerals refer to like elements and its repeated descriptions are omitted. Therefore, the other description, except an arrangement position of the first speaker 110 and the description relevant thereto, of the descriptions of the first speaker 110 described above with reference to FIG. 1 can be included in descriptions of FIG. 3.

The second speaker 120 according to another embodiment of the present disclosure can be in front of the driver seat 11. The second speaker 120 can be configured to output a second sound to a driver 1 in the front of the driver 1. For example, the second speaker 120 can be configured to output the second sound toward ears of the driver 1 in the front of the driver 1.

A distance D2 between the second speaker 120 and the driver 1 according to another embodiment of the present disclosure can be 30 cm or less, but embodiments of the present disclosure are not limited thereto. For example, the distance D2 between the second speaker 120 and the ears of the driver 1 can be 30 cm or less, but embodiments of the present disclosure are not limited thereto.

An angle (θ) between the second speaker 120 and the driver 1 according to another embodiment of the present disclosure can be 30 degrees or more and less than 90 degrees, but embodiments of the present disclosure are not limited thereto. For example, an angle between a sound output direction of the second speaker 120 and the ears of the driver 1 can be 30 degrees or more and less than 90 degrees, but embodiments of the present disclosure are not limited thereto.

The second speaker 120 according to another embodiment of the present disclosure can be disposed (or configured) adjacent to the first speaker 110. The second speaker 120 can be configured at the dashboard 40 adjacent to the first speaker 110. The second speaker 120 can be configured in the dashboard 40 in parallel with the first speaker 110. The second speaker 120 can be configured to output the second sound toward the ears of the driver 1 in front of the driver 1.

The second speaker 120 according to another embodiment of the present disclosure can be driven (or vibrated or displaced) according to a second sound signal based on a sound source to output the second sound. For example, except for that the second speaker 120 is disposed (or configured) in the dashboard 40, the second speaker 120 can be a same or substantially a same as that of the second speaker 120 described above with reference to FIG. 1, and thus, like reference numerals refer to like elements and its repeated descriptions are omitted. Therefore, the other description, except an arrangement position of the second speaker 120 and the description relevant thereto, of the descriptions of the second speaker 120 described above with reference to FIG. 1 can be included in descriptions of FIG. 3.

According to another embodiment of the present disclosure, distances D1 between the driver 1 and each of the first speaker 110 and the second speaker 120 can be equal to each other, but embodiments of the present disclosure are not limited thereto. For example, sound output directions of each of the first speaker 110 and the second speaker 120 can be equal to each other, but embodiments of the present disclosure are not limited thereto. For example, an angle (θ) between a sound output direction of the first speaker 110 and the driver 1 can be equal to an angle (θ) between a sound output direction of the second speaker 120 and the driver 1, but embodiments of the present disclosure are not limited thereto. For example, each of the first speaker 110 and the second speaker 120 can be disposed (or configured) in the dashboard 40 to have a distance D2 of 30 cm or less and a sound output angle (θ) of 30 degrees or more and less than 90 degrees, with respect to the driver 1.

The vehicular apparatus (or the sound system for the vehicular apparatus) according to an embodiment of the present disclosure can further include a directional speaker 190.

The directional speaker 190 can be at a periphery of the driver seat 11. The directional speaker 190 can be configured to output a third sound having directivity to the driver seat 11. The directional speaker 190 can be configured to output (or provide) the third sound corresponding to driving information to the driver 1, at the periphery of the driver seat 11. For example, the directional speaker 190 can be a same or substantially a same as that of the directional speaker 190 described above with reference to FIGS. 1 and 2, and thus, like reference numerals refer to like elements and its repeated descriptions are omitted. Therefore, descriptions of the directional speaker 190 described above with reference to FIGS. 1 and 2 can be included in descriptions of FIG. 3.

The vehicular apparatus (or the sound system for the vehicular apparatus) according to another embodiment of the present disclosure can attenuate (or offset or block) the first sound transferred from the first speaker 110 to the driver 1 by using the second sound output from the second speaker 120, and thus, can minimize or prevent disturbance of the safe driving of the driver 1 caused by the first sound output from the first speaker 110. In addition, the vehicular apparatus (or the sound system for the vehicular apparatus) according to another embodiment of the present disclosure can output the third sound having directivity through the directional speaker 190, and thus, can transfer (or provide) driving information to only the driver 1 through the third sound. Furthermore, the vehicular apparatus (or the sound system for the vehicular apparatus) according to another embodiment of the present disclosure can block the first sound transferred to the driver 1 through destructive interference between the first sound and the second sound and can transfer the driving information to only the driver 1 through the third sound having directivity.

FIG. 4 illustrates a speaker driving circuit according to an embodiment of the present disclosure.

Referring to FIG. 4, the speaker driving circuit 200 according to an embodiment of the present disclosure can be a sound driving circuit part, a sound processing circuit part, a sound driving apparatus, a sound processing apparatus, a sound driving system, or a sound processing system, but embodiments of the present disclosure are not limited thereto.

The speaker driving circuit 200 according to an embodiment of the present disclosure can be configured to apply a first sound signal SS1 to the first speaker 110 and apply a second sound signal SS2, where a phase has been modulated with respect to the first sound signal SS1, to the second speaker 120. For example, the speaker driving circuit 200 can be configured to apply the first sound signal SS1 to the first speaker 110 and apply the second sound signal SS2, having an anti-phase with respect to the first sound signal SS1, to the second speaker 120. Furthermore, the driving circuit 200 according to an embodiment of the present disclosure can be configured to apply a third sound signal SS3 to a directional speaker 190.

According to an embodiment of the present disclosure, the speaker driving circuit 200 can be configured to apply the first sound signal SS1 to the first speaker 110, apply the second sound signal SS2 to the second speaker 120, and apply the third sound signal SS3 to the directional speaker 190, based on a wired communication scheme including a signal cable or a wireless communication scheme including Bluetooth or Wi-Fi.

The speaker driving circuit 200 according to an embodiment of the present disclosure can include a sound source receiver 210 and a sound signal generator 230.

The sound source receiver 210 can be configured to receive sound source signals OS1 and OS2 supplied from a sound source supply device (or a sound source supply system) including a navigation device, a car audio, a digital multimedia broadcasting (DMB) device, or a portable electronic device of a passenger, or the like, but embodiments of the present disclosure are not limited thereto. For example, the sound source receiver 210 can be configured to receive the sound source signals OS1 and OS2 supplied from the sound source supply device through a wired communication module including a signal cable, a universal serial bus (USB) module, or an AUX module, or the like, or receive the sound source signals OS1 and OS2 supplied from the sound source supply device through a wireless communication module including Bluetooth or Wi-Fi, or the like.

The sound source receiver 210 according to an embodiment of the present disclosure can be configured to receive the first sound source signal OS1 and the second sound source signal OS2 supplied from the sound source supply device. For example, the first sound source signal OS1 can include a media sound source (or a multimedia sound source) supplied from the car audio, the DMB device, or the portable electronic device, or the like, but embodiments of the present disclosure are not limited thereto. For example, the second sound source signal OS2 can include driving information supplied from the navigation device, but embodiments of the present disclosure are not limited thereto.

The sound signal generator 230 can be configured to generate and output the first sound signal SS1 and the second sound signal SS2, based on the first sound source signal OS1 supplied from the sound source receiver 210. For example, the sound signal generator 230 can generate the first sound signal SS1 to apply the first sound signal SS1 to the first speaker 110, based on the first sound source signal OS1, and can generate the second sound signal SS2 to apply the second sound signal SS2 to the second speaker 120, based on the first sound source signal OS1. In addition, the sound signal generator 230 can generate the third sound signal SS3 to apply the third sound signal SS3 to the directional speaker 190, based on the second sound source signal OS2.

According to an embodiment of the present disclosure, the sound signal generator 230 can convert the first sound source signal OS1 into a first analog sound signal AS1 and can amplify the first analog sound signal AS1 to generate the first sound signal SS1. The sound signal generator 230 can modulate and amplify a phase of the first analog sound signal AS1 to generate the second sound signal SS2. The sound signal generator 230 can convert the second sound source signal OS2 into a second analog sound signal AS2 and can amplitude-modulate and amplify the second analog sound signal AS2 to generate the third sound signal SS3. Furthermore, the sound signal generator 230 can synchronize a phase of the first sound signal SS1 with a phase of the second sound signal SS2 to output the first sound signal SS1 and the second sound signal SS2.

The sound signal generator 230 according to an embodiment of the present disclosure can include a signal processing circuit 231, a first amplifier circuit 232, a phase modulation circuit 233, a second amplifier circuit 234, an amplitude modulation circuit 235, and a third amplifier circuit 236.

The signal processing circuit 231 can perform digital-analog conversion on the first sound source signal OS1 supplied from the sound source receiver 210 to generate a first analogy sound signal AS1 and can perform digital-analog conversion on the second sound source signal OS2 supplied from the sound source receiver 210 to generate a second analogy sound signal AS2. For example, the signal processing circuit 231 can be configured to include one or more digital-to-analog converters. The signal processing circuit 231 can be configured to generate a carrier signal CS having a frequency of 20 kHz or more, but embodiments of the present disclosure are not limited thereto. For example, the signal processing circuit 231 can be configured to include an oscillation circuit (or ultrasound oscillation circuit) which generates the carrier signal.

The first amplifier circuit 232 can amplify the first analog sound signal AS1 supplied from the signal processing circuit 231 to generate the first sound signal SS1 and can be configured to apply the generated first sound signal SS1 to the first speaker 110. For example, the first amplifier circuit 232 can amplify the first analog sound signal AS1 to generate the first sound signal SS1, based on a predetermined gain value.

The phase modulation circuit 233 can modulate a phase of the first analog sound signal AS1 supplied from the signal processing circuit 231 to generate a phase modulation analog signal PMAS. For example, the phase modulation circuit 233 can invert a phase of the first analog sound signal AS1 to generate the phase modulation analog signal PMAS. For example, the phase modulation circuit 233 can be configured to generate the phase modulation analog signal PMAS having an anti-phase opposite to that of the first analog sound signal AS1. For example, the phase modulation analog signal PMAS and the first analog sound signal AS1 can have a 180-degree phase difference therebetween. For example, the phase modulation analog signal PMAS can be a phase shift analog signal, a phase inversion analog signal, or an anti-phase analog signal, but embodiments of the present disclosure are not limited thereto.

The second amplifier circuit 234 can amplify the phase modulation analog signal PMAS supplied from the phase modulation circuit 233 to generate the second sound signal SS2 and can apply the generated second sound signal SS2 to the second speaker 120. For example, the second amplifier circuit 234 can amplify the phase modulation analog signal PMAS to generate the second sound signal SS2, based on a predetermined gain value. For example, a gain value of the second amplifier circuit 234 can be a same as that of a gain value of the first amplifier circuit 232, but embodiments of the present disclosure are not limited thereto.

The amplitude modulation circuit 235 can amplitude-modulate the second analog sound signal AS2 and the carrier signal CS supplied from the signal processing circuit 231 to generate an amplitude modulation analog signal AMAS. For example, the amplitude modulation circuit 235 can amplitude-modulate an amplitude of the carrier signal CS to generate the amplitude modulation analog signal AMAS, based on the second analog sound signal AS2. For example, the amplitude modulation circuit 235 can amplitude-modulate an amplitude of the carrier signal CS according to the second analog sound signal AS2 to generate the amplitude modulation analog signal AMAS.

The third amplifier circuit 236 can amplify the amplitude modulation analog signal AMAS supplied from the amplitude modulation circuit 235 to generate the third sound signal SS3 and can apply the generated third sound signal SS3 to the directional speaker 190. For example, the third amplifier circuit 236 can amplify the amplitude modulation analog signal AMAS to generate the third sound signal SS3, based on a predetermined gain value.

The sound signal generator 230 according to an embodiment of the present disclosure can further include a phase-locked loop (or a phase synchronization circuit) 237.

The phase-locked loop 237 can be configured to synchronize a phase of the first sound signal SS1, supplied from the first amplifier circuit 232, with a phase of the second sound signal SS2 supplied from the second amplifier circuit 234. For example, the phase-locked loop 237 can be configured so that a phase difference between the first sound signal SS1 and the second sound signal SS2 is 180 degrees, and phases of one or more of the first sound signal SS1 and the second sound signal SS2 are corrected.

According to an embodiment of the present disclosure, the first sound corresponding to the first sound signal SS1 and the second sound corresponding to the second sound signal SS2 can be offset by destructive interference, and thus, may not be transferred to the driver. However, when a phase shift occurs between a phase of the first sound signal SS1 and a phase of the second sound signal SS2, a sound amplification phenomenon can occur due to destructive interference between the first sound and the second sound. Therefore, the phase-locked loop 237 can be configured to so that a phase difference between a phase of the first sound signal SS1 and a phase of the second sound signal SS2 maintains 180 degrees, for complete destructive interference between the first sound and the second sound. For example, the phase-locked loop 237 can detect a phase of the first sound signal SS1 and can correct or shift a phase of the second sound signal SS2 so that a phase difference between the detected phase of the first sound signal SS1 and the phase of the second sound signal SS2 maintains 180 degrees, but embodiments of the present disclosure are not limited thereto.

The sound signal generator 230 according to an embodiment of the present disclosure can further include a signal output part 238.

The signal output part 238 can apply the first sound signal SS1 to the first speaker 110, can apply the second sound signal SS2 to the second speaker 120, and can apply the third sound signal SS3 to the directional speaker 190, based on a wired communication scheme including a signal cable or a wireless communication scheme including Bluetooth or Wi-Fi, or the like.

The signal output part 238 according to an embodiment of the present disclosure can apply the first sound signal SS1 supplied from the first amplifier circuit 232 to the first speaker 110, can apply the second sound signal SS2 supplied from the second amplifier circuit 234 to the second speaker 120, and can apply the third sound signal SS3 supplied from the third amplifier circuit 236 to the directional speaker 190, based on a predetermined wired communication scheme or a predetermined wireless communication scheme.

The signal output part 238 according to another embodiment of the present disclosure can apply the first sound signal SS1 and the second sound signal SS2 supplied from the phase-locked loop 237 to the first speaker 110 and can apply the third sound signal SS3 supplied from the third amplifier circuit 236 to the directional speaker 190, based on a predetermined wired communication scheme or a predetermined wireless communication scheme.

According to an embodiment of the present disclosure, as a display apparatus equipped in a dashboard of a vehicular apparatus enlarges in size, a display part (or a screen) of the display apparatus can extend from a front region with respect to a driver seat to a front region with respect to a passenger seat (or a front passenger seat). For example, an entertainment image or a media image displayed by a display part, which is in front of the passenger seat, of display parts of the display apparatus equipped in the dashboard can interrupt the safe driving of a driver. Accordingly, the display apparatus can include a narrow viewing angle or a privacy mode where an entertainment image displayed by a display part in front of a passenger seat is provided to only a passenger during the driving of the vehicular apparatus and is not provided to a driver.

The inventors of the present disclosure have recognized that an entertainment image is not provided to a driver but a sound corresponding to the entertainment image is still output through a speaker equipped in a vehicular apparatus to interrupt the safe driving of the driver, in the narrow viewing angle or the privacy mode of a display apparatus equipped in the vehicular apparatus and have performed various research and experiments for implementing a vehicular apparatus which can block all of an image and a sound interrupting the safe driving of a driver. This will be described below.

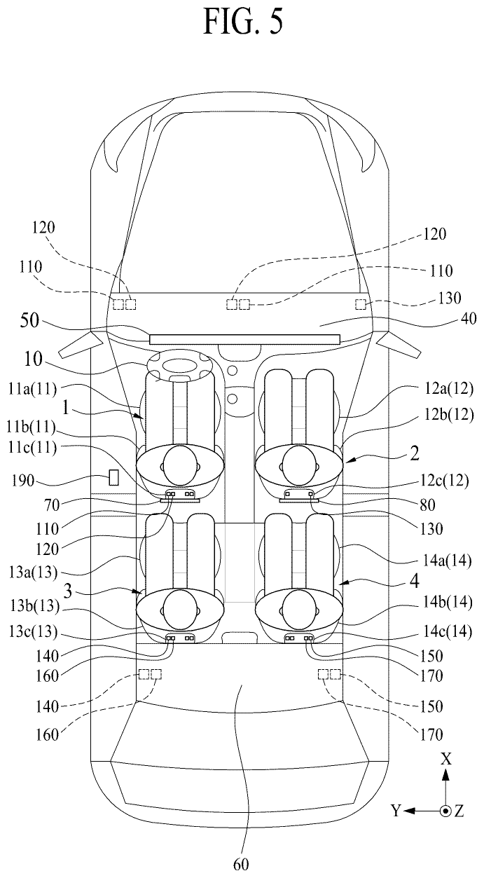

FIG. 5 illustrates a vehicular apparatus according to another embodiment of the present disclosure.

Referring to FIG. 5, the vehicular apparatus according to another embodiment of the present disclosure can include a driver seat 11, a passenger seat 12, a dashboard 40, a display apparatus 50, and first to third speakers 110, 120, and 130.

The driver seat 11 can be a seat for a driver 1 of a vehicular apparatus (or a vehicle). The driver seat 11 can be configured to face a handle 10 of the vehicular apparatus.

The passenger seat (or front passenger seat) 12 can be a seat which is parallel to the driver seat 11 and is for a passenger (or a front passenger) 2 who rides together with a driver 1.

Each of the driver seat 11 and the passenger seat 12 can include a seat cushion 11a and 12a, a seatback 11b and 12b connected to the seat cushion 11a and 12a, and a headrest 11c and 12c connected to an upper portion of the seatback 11b and 12b, but embodiments of the present disclosure are not limited thereto.

The dashboard 40 can be disposed (or configured) in front of the driver seat 11 and the passenger seat 12. The dashboard 40 can include a driver seat region (or a first region) corresponding to the driver seat 11, a passenger seat region (or a second region) corresponding to the passenger seat 12, and a center region (or a third region or a middle region) between the driver seat region and the passenger seat region.

The display apparatus 50 can be in front of the driver seat 11 and the passenger seat 12. The display apparatus 50 can be disposed (or configured) at the dashboard 40 to face the driver seat 11 and the passenger seat 12. For example, the display apparatus 50 can be configured to have a size (or a horizontal length) which extends from the front of the driver seat 11 to the front of the passenger seat 12. For example, the display apparatus 50 can be configured to have a size (or a horizontal length) which extends from a front region with respect to the driver seat 11 to a front region with respect to the passenger seat 12. For example, a first edge portion of the display apparatus 50 can be in front of the driver seat 11, and a second edge portion of the display apparatus 50 can be in front of the passenger seat 12, but embodiments of the present disclosure are not limited thereto. For example, the display apparatus 50 can include a display part which extends from the front of the driver seat 11 to the front of the passenger seat 12. For example, the display apparatus 50 can include a display part which extends from the front region with respect to the driver seat 11 to the front region with respect to the front passenger seat 12.

The display apparatus 50 according to an embodiment of the present disclosure can be configured to include a viewing angle mode which selectively provides an image, displayed by the display part, to the driver 1 sitting on the driver seat 11 and a passenger 2 sitting on the passenger seat 12. For example, the display apparatus 50 can be configured to include a first viewing angle mode which provides all of the image, displayed by the display part, to the driver 1 and the passenger 2 and a second viewing mode which provides an image, displayed on a portion of the display part, to only the passenger 2. For example, the first viewing angle mode can be a wide viewing angle mode, a share mode, or a normal mode, but embodiments of the present disclosure are not limited thereto. For example, the second viewing angle mode can be a narrow viewing angle mode, a private mode, a privacy mode, or a privacy protection mode, but embodiments of the present disclosure are not limited thereto.

The first speaker 110 can be at a periphery of the driver seat 11. The first speaker 110 can be configured to output (or provide) a first sound to the periphery of the driver seat 11. For example, the first speaker 110 can be configured to output, to the periphery of the driver seat 11, the first sound corresponding to a sound associated with an image displayed by the display part of the display apparatus 50. For example, the first speaker 110 can be configured to output the first sound synchronized with the image displayed by the display part, based on the first viewing angle mode and the second viewing angle mode of the display apparatus 50.

The first speaker 110 can be configured in the headrest 11c of the driver seat 11 or can be configured in the first region or the third region of the dashboard 40. For example, the first speaker 110 can be disposed (or configured) in one of the headrest 11c of the driver seat 11, a first edge portion of the dashboard 40, and a center region of the dashboard 40, but embodiments of the present disclosure are not limited thereto. For example, the first speaker 110 can be a same or substantially a same as that of the first speaker 110 described above with reference to FIG. 1 or 3, and thus, like reference numerals refer to like elements and its repeated descriptions are omitted or will be briefly given below. Therefore, the descriptions of the first speaker 110 described above with reference to FIG. 1 or 3 can be included in descriptions of FIG. 5.

The second speaker 120 can be at the periphery of the driver seat 11. The second speaker 120 can be configured to output (or provide) a second sound to the periphery of the driver seat 11. For example, the second speaker 120 can be configured to output (or provide), to the periphery of the driver seat 11, a second sound for attenuating (or offsetting or blocking) the first sound, transferred (or output) from the first speaker 110 to the driver 1, of the first sound corresponding to the sound associated with the image displayed by the display part of the display apparatus 50. For example, the second speaker 120 can be configured to output (or provide), to the periphery of the driver seat 11, the second sound for attenuating (or offsetting or blocking) the first sound synchronized with the image displayed by the display part, based on the second viewing angle mode of the display apparatus 50. For example, the second sound can have an anti-phase with respect to the first sound, but embodiments of the present disclosure are not limited thereto.

The second speaker 120 can be configured in the headrest 11c of the driver seat 11 so as to be adjacent to the first speaker 110, or can be configured in the first region or the third region of the dashboard 40 so as to be adjacent to the first speaker 110. For example, the second speaker 120 can be disposed (or configured) in any one of the headrest 11c of the driver seat 11, the first edge portion (or one side of a front left region) of the dashboard 40 facing the driver seat 11, and the center region (or the other side of the driver seat region) of the dashboard 40 so as to be adjacent to the first speaker 110, but embodiments of the present disclosure are not limited thereto. For example, the second speaker 120 can be a same or substantially a same as that of the second speaker 120 described above with reference to FIG. 1 or 3, and thus, like reference numerals refer to like elements and its repeated descriptions are omitted or will be briefly given below. Therefore, the descriptions of the second speaker 120 described above with reference to FIG. 1 or 3 can be included in descriptions of FIG. 5.

The third speaker 130 can be at a periphery of the passenger seat 12. The third speaker 130 can be configured to output (or provide) a first sound to the periphery of the passenger seat 12. For example, the third speaker 130 can be configured to output (or provide), to the periphery of the passenger seat 12, a same first sound as the first sound output from the first speaker 110.

The third speaker 130 can be configured in the passenger seat region of the dashboard 40 in front of the passenger seat 12 or the headrest 12c of the passenger seat 12. For example, the third speaker 130 can be disposed (or configured) in the headrest 12c of the passenger seat 12 or a second edge portion of the dashboard 40 facing the passenger seat 12, but embodiments of the present disclosure are not limited thereto. For example, except for being disposed at the periphery of the passenger seat 12, the third speaker 130 can be a same or substantially the same as the first speaker 110 described above with reference to FIG. 1 or 3, and thus, its repeated descriptions are omitted or will be briefly given below. Therefore, the descriptions of the first speaker 110 described above with reference to FIG. 1 or 3 can be included in descriptions of the third speaker 130 illustrated in FIG. 5.

According to an embodiment of the present disclosure, the first speaker 110 and the third speaker 130 can output the first sound, synchronized with an image displayed by the display part, to the periphery of each of the driver seat 11 and the passenger seat 12, based on the first viewing angle mode of the display apparatus 50. Accordingly, the driver 1 can listen to the first sound output from the first speaker 110, and the passenger 2 can listen to the first sound output from the third speaker 130.

According to another embodiment of the present disclosure, the first speaker 110 and the third speaker 130 can output the first sound, synchronized with an image displayed by the display part, to the periphery of each of the driver seat 11 and the passenger seat 12, based on the second viewing angle mode of the display apparatus 50, and the second speaker 120 can output the second sound, having an anti-phase opposite to that of the first sound, to the periphery of the driver seat 11. Accordingly, the passenger 2 can listen to the first sound output from the third speaker 130, and the driver 1 may not listen to the first sound due to destructive interference between the first sound output from the first speaker 110 and the second sound output from the second speaker 120, and thus, safe driving may not be interrupted by the first sound.

The vehicular apparatus according to another embodiment of the present disclosure can further include a directional speaker 190.

The directional speaker 190 can be at the periphery of the driver seat 11. The directional speaker 190 can be configured to output a third sound having directivity to the driver seat 11. The directional speaker 190 can be configured to output (or provide) the third sound corresponding to driving information to the driver 1, at the periphery of the driver seat 11. For example, the directional speaker 190 can be a same or substantially a same as that of the directional speaker 190 described above with reference to FIGS. 1 and 2, and thus, like reference numerals refer to like elements and its repeated descriptions are omitted. Therefore, descriptions of the directional speaker 190 described above with reference to FIGS. 1 and 2 can be included in descriptions of FIG. 5.

The vehicular apparatus (or the sound system for the vehicular apparatus) according to an embodiment of the present disclosure can further output the third sound having directivity through the directional speaker 190, and thus, can transfer (or provide) driving information to only the driver 1 through the third sound.

The vehicular apparatus according to another embodiment of the present disclosure can further include a first rear passenger seat 13, a second rear passenger seat 14, a rear package interior material 60, a fourth speaker 140, and a fifth speaker 150.

The first rear passenger seat 13 can be behind the driver seat 11. The first rear passenger seat 13 can be a seat for a first rear passenger 3 who rides together with a driver 1.

The second rear passenger seat 14 can be behind the passenger seat 12. The second rear passenger seat 14 can be a seat for a second rear passenger 4 who rides together with the driver 1.

Each of the first rear passenger seat 13 and the second rear passenger seat 14 can include a seat cushion 13a and 14a, a seatback 13b and 14b connected to the seat cushion 13a and 14a, and a headrest 13c and 14c connected to an upper portion of the seatback 13b and 14b.

The rear package interior material (or a rear passenger seat shelf) 60 can be behind the first rear passenger seat 13 and the second rear passenger seat 14.

The fourth speaker 140 can be at a periphery of the first rear passenger seat 13. The fourth speaker 140 can be configured to output (or provide) the first sound to the periphery of the first rear passenger seat 13. For example, the fourth speaker 140 can be configured to output, to the periphery of the first rear passenger seat 13, the first sound corresponding to a sound associated with an image displayed by the display part of the display apparatus 50. For example, the fourth speaker 140 can be configured to output the first sound synchronized with the image displayed by the display part, based on the first viewing angle mode and the second viewing angle mode of the display apparatus 50.

The fourth speaker 140 can be disposed (or configured) in any one of a headrest 13c of the first rear passenger seat 13 and a first rear package of the rear package interior material 60 behind the first rear passenger seat 13. For example, except for being disposed at the periphery of the first rear passenger seat 13, the fourth speaker 140 can be a same or substantially the same as the first speaker 110 described above with reference to FIG. 1 or 3, and thus, its repeated descriptions are omitted or will be briefly given below. Therefore, the descriptions of the first speaker 110 described above with reference to FIG. 1 or 3 can be included in descriptions of the fourth speaker 140 illustrated in FIG. 5.

The fifth speaker 150 can be at a periphery of the second rear passenger seat 14. The fifth speaker 150 can be configured to output (or provide) the first sound to the periphery of the second rear passenger seat 14. For example, the fifth speaker 150 can be configured to output, to the periphery of the second rear passenger seat 14, the first sound corresponding to a sound associated with an image displayed by the display part of the display apparatus 50. For example, the fifth speaker 150 can be configured to output the first sound synchronized with the image displayed by the display part, based on the first viewing angle mode and the second viewing angle mode of the display apparatus 50.

The fifth speaker 150 can be disposed (or configured) in any one of a headrest 14c of the second rear passenger seat 14 and a second rear package of the rear package interior material 60 behind the second rear passenger seat 14. For example, except for being disposed at the periphery of the second rear passenger seat 14, the fifth speaker 150 can be a same or substantially the same as the first speaker 110 described above with reference to FIG. 1 or 3, and thus, its repeated descriptions are omitted or will be briefly given below. Therefore, the descriptions of the first speaker 110 described above with reference to FIG. 1 or 3 can be included in descriptions of the fifth speaker 150 illustrated in FIG. 5.

The vehicular apparatus according to another embodiment of the present disclosure can further include a sixth speaker 160 and a seventh speaker 170.

The sixth speaker 160 can be at the periphery of the first rear passenger seat 13. The sixth speaker 160 can be configured to output (or provide) the second sound to the periphery of the first rear passenger seat 13. For example, the sixth speaker 160 can be configured to output (or provide), to the periphery of the first rear passenger seat 13, a second sound for attenuating (or offsetting or blocking) the first sound, transferred (or output) from the fourth speaker 140 to the first rear passenger 3, of the first sound corresponding to the sound associated with the image displayed by the display part of the display apparatus 50. For example, the sixth speaker 160 can be configured to output (or provide), to the periphery of the first rear passenger seat 13, the second sound for attenuating (or offsetting or blocking) the first sound synchronized with the image displayed by the display part, based on the second viewing angle mode of the display apparatus 50.

The sixth speaker 160 can be disposed (or configured) in any one of the headrest 13c of the first rear passenger seat 13 and the first rear package of the rear package interior material 60 so as to be adjacent to the fourth speaker 140, but embodiments of the present disclosure are not limited thereto. For example, except for being disposed at the periphery of the first rear passenger seat 13, the sixth speaker 160 can be a same or substantially the same as the second speaker 120 described above with reference to FIG. 1 or 3, and thus, its repeated descriptions are omitted or will be briefly given below. Therefore, the descriptions of the second speaker 120 described above with reference to FIG. 1 or 3 can be included in descriptions of the sixth speaker 160 illustrated in FIG. 5.

The seventh speaker 170 can be at the periphery of the second rear passenger seat 14. The seventh speaker 170 can be configured to output (or provide) the second sound to the periphery of the second rear passenger seat 14. For example, the seventh speaker 170 can be configured to output (or provide), to the periphery of the second rear passenger seat 14, a second sound for attenuating (or offsetting or blocking) the first sound, transferred (or output) from the fifth speaker 150 to the second rear passenger 4, of the first sound corresponding to the sound associated with the image displayed by the display part of the display apparatus 50. For example, the seventh speaker 170 can be configured to output (or provide), to the periphery of the second rear passenger seat 14, the second sound for attenuating (or offsetting or blocking) the first sound synchronized with the image displayed by the display part, based on the second viewing angle mode of the display apparatus 50.

The seventh speaker 170 can be disposed (or configured) in any one of the headrest 14c of the second rear passenger seat 14 and the second rear package of the rear package interior material 60 so as to be adjacent to the fifth speaker 150. For example, except for being disposed at the periphery of the second rear passenger seat 14, the seventh speaker 170 can be a same or substantially the same as the second speaker 120 described above with reference to FIG. 1 or 3, and thus, its repeated descriptions are omitted or will be briefly given below. Therefore, the descriptions of the second speaker 120 described above with reference to FIG. 1 or 3 can be included in descriptions of the seventh speaker 170 illustrated in FIG. 5.

According to an embodiment of the present disclosure, the fourth speaker 140 and the fifth speaker 150 can output the first sound, synchronized with an image displayed by the display part, to the periphery of each of the first rear passenger seat 13 and the second rear passenger seat 14, based on the first viewing angle mode of the display apparatus 50. Accordingly, the first rear passenger 3 can listen to the first sound output from the fourth speaker 140, and the second rear passenger 4 can listen to the first sound output from the fifth speaker 150.

According to another embodiment of the present disclosure, the fourth speaker 140 and the fifth speaker 150 can output the first sound, synchronized with an image displayed by the display part, to the periphery of each of the first rear passenger seat 13 and the second rear passenger seat 14, based on the second viewing angle mode of the display apparatus 50, and each of the sixth speaker 160 and the seventh speaker 170 can output the second sound, having an anti-phase opposite to that of the first sound, to the periphery of each of the first rear passenger seat 13 and the second rear passenger seat 14. Therefore, the first rear passenger 3 may not listen to the first sound due to destructive interference between the first sound output from the fourth speaker 140 and the second sound output from the sixth speaker 160, and thus, can perform office tasks (or private works) or can have a deep sleep without being interrupted by the first sound. In addition, the second rear passenger 4 may not listen to the first sound due to destructive interference between the first sound output from the fifth speaker 150 and the second sound output from the seventh speaker 170, and thus, can perform office tasks (or private works) or can have a deep sleep without being interrupted by the first sound.

The vehicular apparatus according to another embodiment of the present disclosure can further include a first auxiliary display apparatus 70 and a second auxiliary display apparatus 80.

The first auxiliary display apparatus 70 can be at a rear surface of the driver seat 11. The first auxiliary display apparatus 70 can be disposed (or configured) at the rear surface of the driver seat 11. The first auxiliary display apparatus 70 can be disposed (or configured) at the rear surface of the driver seat 11 to face the first rear passenger seat 13. For example, the first auxiliary display apparatus 70 can be disposed (or configured) in any one of an upper portion of the seatback 11b of the driver seat 11, a rear surface of the headrest 11c, and a region between the seatback 11b and the headrest 11c. The first auxiliary display apparatus 70 can be configured to provide an image and a sound (or a fourth sound) to the first rear passenger 3 sitting on the first rear passenger seat 13. For example, the first auxiliary display apparatus 70 can be configured to include a display part displaying an image and an embedded speaker outputting a sound associated with the image displayed by the display part.

The second auxiliary display apparatus 80 can be at a rear surface of the passenger seat 12. The second auxiliary display apparatus 80 can be disposed (or configured) at the rear surface of the passenger seat 12. The second auxiliary display apparatus 80 can be disposed (or configured) at the rear surface of the passenger seat 12 to face the second rear passenger seat 14. For example, the second auxiliary display apparatus 80 can be disposed (or configured) in any one of an upper portion of the seatback 12b of the passenger seat 12, a rear surface of the headrest 12c, and a region between the seatback 12b and the headrest 12c. The second auxiliary display apparatus 80 can be configured to provide an image and a sound (or a fifth sound) to the second rear passenger 4 sitting on the second rear passenger seat 14. For example, the second auxiliary display apparatus 80 can be configured to include a display part displaying an image and an embedded speaker outputting a sound associated with the image displayed by the display part.

One or more of the first auxiliary display apparatus 70 and the second auxiliary display apparatus 80 can be a portable multimedia player (PMP), a laptop PC, a netbook computer, or a signage device, but embodiments of the present disclosure are not limited thereto.

According to an embodiment of the present disclosure, one or more of the first auxiliary display apparatus 70 and the second auxiliary display apparatus 80 can be configured to display an image which is a same as or different from an image displayed by the display part of the display apparatus 50. For example, one or more of the first auxiliary display apparatus 70 and the second auxiliary display apparatus 80 can be configured to share an image displayed by the display part of the display apparatus 50 or display an independent image.

The first auxiliary display apparatus 70 can be configured to include a share display mode which shares an image displayed by the display part of the display apparatus 50, based on a selection of the first rear passenger 3, and an independent display mode which displays an independent image. In addition, the second auxiliary display apparatus 80 can be configured to include a share display mode which shares an image displayed by the display part of the display apparatus 50, based on a selection of the second rear passenger 4, and an independent display mode which displays an independent image.

In the share display mode, each of the first auxiliary display apparatus 70 and the second auxiliary display apparatus 80 can display the image displayed by the display part of the display apparatus 50 together and may not output a first sound corresponding to the image displayed by the display part of the display apparatus 50, but embodiments of the present disclosure are not limited thereto. For example, when each of the first auxiliary display apparatus 70 and the second auxiliary display apparatus 80 is in the share display mode, the first sound corresponding to the image displayed by the display part of the display apparatus 50 can be provided to the first rear passenger 3 through the fourth speaker 140 and can be provided to the second rear passenger 4 through the fifth speaker 150.

In the independent display mode, each of the first auxiliary display apparatus 70 and the second auxiliary display apparatus 80 can be configured to display an image, differing from the image displayed by the display part of the display apparatus 50, or output a sound corresponding to the displayed image. For example, when the first auxiliary display apparatus 70 is in the independent display mode, the first sound provided to the first rear passenger 3 through the fourth speaker 140 can be offset by a second sound output through the sixth speaker 160, and thus, the first rear passenger 3 can be provided with an image and a sound from the first auxiliary display apparatus 70 without being interrupted by the first sound output from the fourth speaker 140. For example, when the second auxiliary display apparatus 80 is in the independent display mode, the first sound provided to the second rear passenger 4 through the fifth speaker 150 can be offset by a second sound output through the seventh speaker 170, and thus, the second rear passenger 4 can be provided with an image and a sound from the second auxiliary display apparatus 80 without being interrupted by the first sound output from the fifth speaker 150.

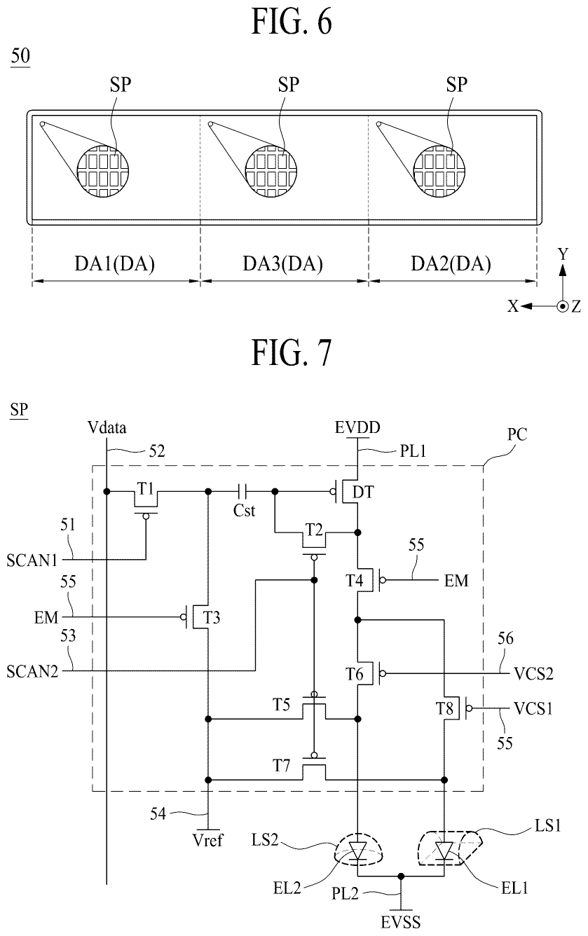

FIG. 6 illustrates a display apparatus according to an embodiment of the present disclosure illustrated in FIG. 5.

Referring to FIGS. 5 and 6, the display apparatus 50 according to an embodiment of the present disclosure can include a display part DA.

The display part DA can be configured to extend from a front region with respect to a driver seat 11 to a front region with respect to a passenger seat 12. For example, the display part DA can include a first display part DA1, a second display part DA2, and a third display part DA3.

The first display part DA1 can be in front of the driver seat 11. For example, the first display part DA1 can include one side (or a first portion) of the display part DA facing the driver seat 11. For example, the first display part DA1 can be configured to display a first image. For example, the first image can include instrument panel information associated with an instrument panel of a vehicular apparatus. For example, the first image can include state information and driving-related information such as a driving speed, the amount of fuel, the amount of fuel consumption, a remaining capacity of a battery, and engine revolutions per minute (RPM), but embodiments of the present disclosure are not limited thereto. For example, the first display part DA1 can be a cluster display part.

The second display part DA2 can be in front of the passenger seat 12. For example, the second display part DA2 can include the other side (or a second portion) of the display part DA facing the passenger seat 12. For example, the second display part DA2 can be configured to display a second image. For example, the second image can differ from the first image, but embodiments of the present disclosure are not limited thereto. For example, the second image can include an entertainment image, a media image, or a multimedia image, but embodiments of the present disclosure are not limited thereto. For example, the second image can display a movie, television broadcast content, real-time television broadcast program, Internet content, or Internet video content, but embodiments of the present disclosure are not limited thereto. For example, the second display part DA2 can be a co-driver display part, a first switchable share display part, or a first switchable privacy display part, but embodiments of the present disclosure are not limited thereto.

The third display part DA3 can be between the first display part DA1 and the second display part DA2. For example, the third display part DA3 can include a center portion of the display part DA facing a region between the driver seat 11 and the passenger seat 12. For example, the third display part DA3 can be configured to display a third image. For example, the third image can differ from each of the first image and the second image, but embodiments of the present disclosure are not limited thereto. For example, the third image can include one or more of a navigation image and a camera image, but embodiments of the present disclosure are not limited thereto. For example, the camera image can include one or more of a front camera image, a rear camera image, a side camera image, and a surround camera image, but embodiments of the present disclosure are not limited thereto. For example, the third display part DA3 can be a center information display part, a second switchable share display part, or a second switchable privacy display part, but embodiments of the present disclosure are not limited thereto.

According to an embodiment of the present disclosure, the third display part DA3 can be configured to display the second image together with the second display part DA2. For example, the second image displayed by the second display part DA2 can extend to the third display part DA3, based on a selection of each of the driver 1 and passengers 2 to 4.

The display part DA (or first to third display parts DA1, DA2, and DA3) according to an embodiment of the present disclosure can include a plurality of subpixels SP.

Each of the plurality of subpixels SP can be configured to display an image. The plurality of subpixels SP can be arranged (or configured) in a matrix form. Each of the plurality of subpixels SP according to an embodiment of the present disclosure can be configured to switch to any one of the first viewing angle mode having a wide viewing angle and the second viewing angle mode having a narrow viewing angle which is narrower than the wide viewing angle.

Each subpixel SP can be any one of a red subpixel for emitting red light, a green subpixel for emitting green light, a blue subpixel for emitting blue light, and a white subpixel for emitting white light, but embodiments of the present disclosure are not limited thereto. At least three subpixels SP adjacent to one another of the plurality of subpixels SP can configure one unit pixel which implements one color (or a color image).

Each of the plurality of subpixels SP can include a circuit device layer including a plurality of transistors disposed on a substrate, a light emitting device layer including a plurality of light emitting devices disposed on the circuit device layer, an encapsulation layer disposed to seal the light emitting device layer, a touch sensor (or a touch part) including a plurality of touch electrodes disposed on the encapsulation layer, and a lens layer including a plurality of lenses disposed on the touch sensor.

According to an embodiment of the present disclosure, the light emitting device layer can include a first light emitting device and a second light emitting device which are disposed on the circuit device layer. The first light emitting device and the second light emitting device can selectively emit light corresponding to the viewing angle mode. For example, the first light emitting device can emit light corresponding to the first viewing angle mode, and the second light emitting device can emit light corresponding to the second viewing angle mode.

According to an embodiment of the present disclosure, the lens layer can include a first lens corresponding to (or overlapping) the first light emitting device and a second lens corresponding to (or overlapping) the second light emitting device. For example, with respect to a plane, the first lens and the second lens can differently control (or limit) a viewing angle in a left-right direction (or a horizontal direction) X and can identically control a viewing angle in an upward and downward direction (or a vertical direction) Y. For example, the first lens can be configured to control a subpixel at the wide viewing angle, and the second lens can be configured to control a subpixel at the narrow viewing angle. For example, the first lens can be a semicylindrical shape or a semi-circular pillar shape which extends long in a first direction X or the horizontal direction, and the second lens can be a semispherical shape, but embodiments of the present disclosure are not limited thereto.

According to an embodiment of the present disclosure, each of a plurality of subpixels SP configured in the first display part DA1 can be driven in the first viewing angle mode or the second viewing angle mode. For example, based on the first viewing angle mode, a first image displayed by the first display part DA1 can be provided to the driver 1 and passengers 2 to 4 of a vehicular apparatus. For example, based on the second viewing angle mode, the first image displayed by the first display part DA1 can be provided to the driver 1 and a first rear passenger 3.

According to an embodiment of the present disclosure, each of a plurality of subpixels SP configured in the second display part DA2 can be driven in the first viewing angle mode or the second viewing angle mode. For example, based on the first viewing angle mode, a second image displayed by the second display part DA2 can be provided to all of the driver 1 and passengers 2 to 4 of the vehicular apparatus. For example, based on the second viewing angle mode, the second image displayed by the second display part DA2 can be provided to a second rear passenger 4 and the passenger 2 sitting on the passenger seat 12.

According to an embodiment of the present disclosure, based on the first viewing angle mode or the second viewing angle mode, the second image displayed by the second display part DA2 can be displayed together by display parts of one or more of the first auxiliary display apparatus 70 and the second auxiliary display apparatus 80, based on a selection of the passenger 2.

According to an embodiment of the present disclosure, based on the first viewing angle mode, a first sound corresponding to the second image displayed by the second display part DA2 can be provided to all of the driver 1 and passengers 2 to 4 of the vehicular apparatus. For example, based on the second viewing angle mode, a first sound corresponding to the second image displayed by the second display part DA2 can be provided to the passenger 2, the first rear passenger 3, and the second rear passenger 4 through the third to fifth speakers 130, 140, and 150, or can be provided to the passenger 2 through the third speaker 130.

According to an embodiment of the present disclosure, based on the second viewing angle mode, a first sound which corresponds to the second image displayed by the second display part DA2 and is output to a periphery of the driver 1 through the first speaker 110 can be offset by a second sound output to the periphery of the driver 1 through the second speaker 120 and may not be transferred to the driver 1. For example, based on the second viewing angle mode, a first sound which corresponds to the second image displayed by the second display part DA2 and is output to a periphery of the first rear passenger 3 through the fourth speaker 140 can be offset by a second sound output to the periphery of the first rear passenger 3 through the sixth speaker 160 and may not be transferred to the first rear passenger 3. For example, based on the second viewing angle mode, a first sound which corresponds to the second image displayed by the second display part DA2 and is output to a periphery of the second rear passenger 4 through the fifth speaker 150 can be offset by a second sound output to the periphery of the second rear passenger 4 through the seventh speaker 170 and may not be transferred to the second rear passenger 4.

According to an embodiment of the present disclosure, each of a plurality of subpixels SP configured in the second display part DA2 can be driven in the first viewing angle mode or the second viewing angle mode. For example, based on the first viewing angle mode, the second image displayed by the second display part DA2 can be provided to all of the driver 1 and passengers 2 to 4 of the vehicular apparatus. For example, based on the second viewing angle mode, the second image displayed by the second display part DA2 can be provided to the driver 1 and the first rear passenger 3. For example, based on the first viewing angle mode or the second viewing angle mode, a third sound corresponding to the second image displayed by the second display part DA2 can be provided to only the driver 1 through the directional speaker 190.

FIG. 7 is an equivalent circuit view illustrating a circuit configuration of each of a plurality of subpixels according to an embodiment of the present disclosure illustrated in FIG. 6.

Referring to FIG. 7, each of a plurality of subpixels SP according to an embodiment of the present disclosure can include a pixel circuit PC, a first light emitting device EL1, a second light emitting device EL2, a first lens LS1, and a second lens LS2.

The pixel circuit PC can be configured to selectively allow the first light emitting device EL1 and the second light emitting device EL2 to emit. For example, the pixel circuit PC can be configured to selectively allow the first light emitting device EL1 and the second light emitting device EL2 to emit, based on a first viewing angle control signal VCS1 (or a first mode control signal) and a second viewing angle control signal VCS2 (or a second mode control signal).

The pixel circuit PC can be driven to include an initialization period, a sampling and program period, and an emission period for each frame period, but embodiments of the present disclosure are not limited thereto. The frame period can be distinguished by being synchronized with a vertical synchronization signal, and can include a blank period and an active period, but embodiments of the present disclosure are not limited thereto. For example, mode change based on the inversion of voltage levels of first and second mode control signals MCL1 and MCL2 can be performed in the blank period of the vertical synchronization signal.

The pixel circuit PC can include a plurality of transistors DT and T1 to T8. For example, the pixel circuit PC can include first to eighth switching transistors T1 to T8, a driving transistor DT, and a storage capacitor Cst, but embodiments of the present disclosure are not limited thereto. For example, the eighth transistor T8 can be a first mode control transistor T8 or a first viewing angle control transistor T8, and the sixth transistor T6 can be a second mode control transistor T6 or a second viewing angle control transistor T6, but embodiments of the present disclosure are not limited thereto.

The first light emitting device EL1 can be driven by the first mode control transistor T8 controlled by the first viewing angle control signal VCS1, and the second light emitting device EL2 can be driven by the second mode control transistor T6 controlled by the second viewing angle control signal VCS2. The first lens LS1 disposed in a light moving direction of the first light emitting device EL1 can be configured to control the viewing angle in the left-right direction at the wide viewing angle. The second lens LS2 disposed in a light moving direction of the second light emitting device EL2 can be configured to control the viewing angle in the left-right direction at the narrow viewing angle.

Each of the plurality of transistors DT and T1 to T8 includes a gate electrode, a source electrode and a drain electrode. Since the source electrode and the drain electrode can be changed depending on a voltage applied to the gate electrode and a current direction without being fixed, any one of the source electrode and the drain electrode can be expressed as a first electrode, and the other one can be expressed as a second electrode, but embodiments of the present disclosure are not limited thereto. Each of the plurality of transistors DT and T1 to T8 can be configured in at least one or a combination of a polysilicon semiconductor, a low-temperature polysilicon semiconductor, an amorphous silicon semiconductor, and an oxide semiconductor. The plurality of transistors DT and T1 to T8 can be P-type or N-type transistors, or P-type and N-type transistors can be used interchangeably.

Each of the light emitting devices EL1 and EL2 can include an anode electrode individually connected to the mode control transistor T8 and T6, a cathode electrode supplied with a second power voltage EVSS from a second power line PL2, and a light emitting layer between the anode electrode and the cathode electrode. The anode electrode is an independent electrode for each light emitting device, but the cathode electrode can be a common electrode shared by the entire light emitting devices. Each of the first and second light emitting devices EL1 and EL2 can be configured to emit light with a driving current supplied from the driving transistor DT through the mode control transistors T8 and T6.

The first electrode of the driving transistor DT can be connected to a first power line PL1 for supplying the first power voltage EVDD. For example, the second electrode of the driving transistor DT can be commonly connected to the first electrodes of the first and second mode control transistors T8 and T6 through the fourth switching transistor T4. The driving transistor DT can allow the first light emitting device EL1 to emit light through the fourth switching transistor T4 and the first mode control transistor T8, or can allow the second light emitting device EL2 to emit light through the fourth switching transistor T4 and the second mode control transistor T6.

The storage capacitor Cst can be connected between the gate electrode and the first electrode of the driving transistor DT and can charge a driving voltage corresponding to data voltage Vdata. The storage capacitor Cst can hold the charged driving voltage during the emission period at which the first switching transistor T1 is turned off, thereby supplying the driving voltage to the driving transistor DT.

The first switching transistor T1 can be turned-on or turned-off in response to a first scan signal SCAN1 supplied to a first gate line 51. The first switching transistor T1 can supply the data voltage Vdata supplied through the data line 52 to the first electrode of the storage capacitor Cst in response to the gate-on voltage of the first scan signal SCAN1 during the sampling and program period.

The second, fifth and seventh switching transistors T2, T5 and T7 can be turned-on or turned-off in response to the second scan signal SCAN2 supplied to a second gate line 53.

The second switching transistor T2 can be configured to connect the gate electrode with the second electrode (or source electrode) of the driving transistor DT in response to a gate-on voltage of the second scan signal SCAN2 during the initialization period and the sampling and program period. For example, the second switching transistor T2 can connect the driving transistor DT to a diode structure in response to the gate-on voltage of the second scan signal SCAN2. The second switching transistor T2 can charge a threshold voltage Vth of the driving transistor DT in the storage capacitor Cst and compensate for the threshold voltage Vth. Therefore, the storage capacitor Cst can be charged with the data voltage Vdata+Vth, for which the threshold voltage Vth of the driving transistor DT is compensated, during the sampling and program period.

The fifth switching transistor T5 can supply an initialization voltage (or a reference voltage) Vref supplied through an initialization voltage line 54 to the anode electrode of the second light emitting device EL2 in response to a gate-on voltage of the second scan signal SCAN2, during the initialization period and the sampling and program period.

The seventh switching transistor T7 can supply the initialization voltage (or the reference voltage) Vref supplied through the initialization voltage line 54 to the anode electrode of the first light emitting device EL1 in response to the gate-on voltage of the second scan signal SCAN2, during the initialization period and the sampling and program period.

The third switching transistor T3 can be turned-on or turned-off in response to an emission control signal EM supplied to a third gate line 55. For example, the third switching transistor T3 can supply the initialization voltage Vref supplied through the initialization voltage line 54 to the first electrode of the storage capacitor Cst in response to a gate-on voltage of the emission control signal EM, during the initialization period and the emission period.

The fourth switching transistor T4 can be configured to commonly connect the driving transistor DT with the sixth and eighth transistors (or the first and second mode control transistors) T6 and T8 in response to the gate-on voltage of the emission control signal EM, during the initialization period and the emission period.

The first mode control transistor T8 can be turned-on or turned-off by being controlled by the first viewing angle control signal VCS1 supplied to a first mode control line 55, and the second mode control transistor T6 can be turned-on or turned-off by being controlled by the second viewing angle control signal VCS2 supplied to a second mode control line 56.

The first mode control transistor T8 can be configured to electrically connect the driving transistor DT with the first light emitting device EL1 in response to a gate-on voltage of the first viewing angle control signal VCS1 during the emission period at which the fourth switching transistor T4 is turned-on by the emission control signal EM. The first light emitting device EL1 can emit light by a driving current from the driving transistor DT. Light emitted from the first light emitting device EL1 of the subpixel SP can be irradiated at the wide viewing angle through the first lens LS1, and thus, the subpixel SP can be driven (or switched) in the wide viewing angle mode by the first lens LS1.

The second mode control transistor T6 can be configured to electrically connect the driving transistor DT with the second light emitting device EL2 in response to a gate-on voltage of the second viewing angle control signal VCS2 during the emission period at which the fourth switching transistor T4 is turned-on by the emission control signal EM. The second light emitting device EL2 can emit light by a driving current from the driving transistor DT. Light emitted from the second light emitting device EL2 of the subpixel SP can be irradiated at the narrow viewing angle through the second lens LS2, and thus, the subpixel SP can be driven (or switched) in the narrow viewing angle mode by the second lens LS2.

According to an embodiment of the present disclosure, the first lens LS1 can be disposed on a light moving path of the first light emitting device EL1. The second lens LS2 can be disposed on a light moving path of the second light emitting device EL2. For example, the first lens LS1 can control the viewing angle at a wide viewing angle as a moving path of light emitted from the first light emitting device EL1 is not limited within a specific angle in the left-right direction X, and the second lens LS2 can control the viewing angle at a narrow viewing angle as a moving path of light emitted from the second light-emitting device EL2 is limited within a specific angle in the left-right direction X.

According to an embodiment of the present disclosure, each of a plurality of subpixels SP disposed in the first to third display parts DA1, DA2, and DA3 can selectively allow each of the first and second light emitting devices EL1 and EL2 to emit light based on the viewing angle control signals VCS1 and VCS2 and can be driven (or switched) in the wide viewing angle mode and the narrow viewing angle mode by the first lens LS1 and the second lens LS2.

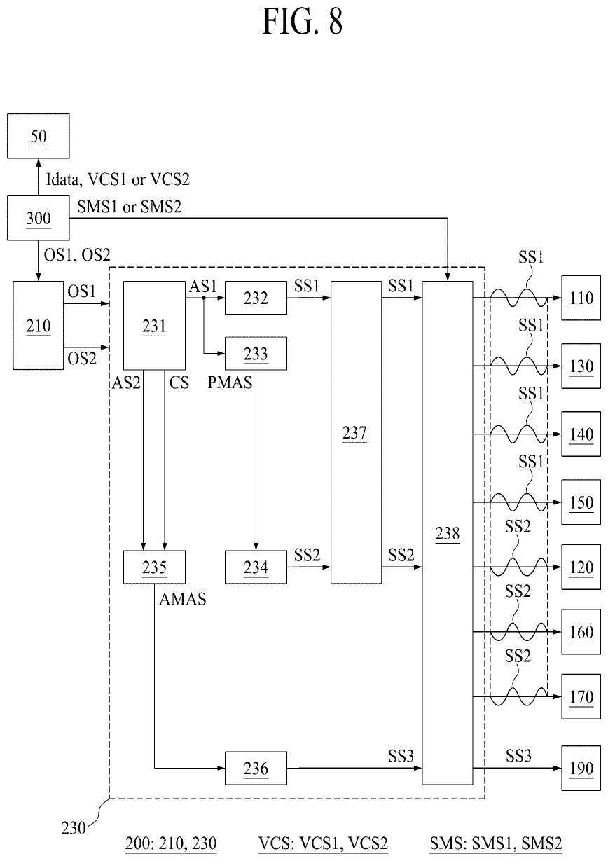

FIG. 8 illustrates a circuit for a sound output of a vehicular apparatus according to another embodiment of the present disclosure. For example, FIG. 8 illustrates a circuit for a sound output of a vehicular apparatus according to another embodiment of the present disclosure described above with reference to FIGS. 5 to 7.

Referring to FIGS. 5, 6, and 8, a vehicular apparatus according to an embodiment of the present disclosure can include a control circuit 300 and a speaker driving circuit 200.

The control circuit 300 can be a main control circuit (or a main control device) which is configured to control an overall operation of the vehicular apparatus, but embodiments of the present disclosure are not limited thereto. For example, the control circuit 300 can be a sound control circuit (or a sound control device) which is configured to control a sound output of the vehicular apparatus. For example, the control circuit 300 can be implemented through a memory and a device capable of performance of various operation processing like a microcontroller unit (MCU) and a processor, or the like.

The control circuit 300 according to an embodiment of the present disclosure can generate an image signal Idata and sound source signals OS1 and OS2, based on an image source from an image supply device (or an image supply system), can supply the image signal Idata to the display apparatus 50, and can be configured to supply the sound source signals OS1 and OS2 to the speaker driving circuit 200. For example, the image supply device can include a navigation device, a digital multimedia broadcasting (DMB) device, or a portable electronic device of a passenger, or the like, but embodiments of the present disclosure are not limited thereto. For example, the control circuit 300 can be configured to receive the image source supplied from the image supply device through a wired communication module including a universal serial bus (USB) module or the like, or receive the image source supplied from the image supply device through a wireless communication module including Bluetooth or Wi-Fi, or the like.

The image signal Idata according to an embodiment of the present disclosure can include one or more of a second image signal which is to be displayed by the second display part DA2 of the display apparatus 50 and a third image signal which is to be displayed by the third display part DA3 of the display apparatus 50.

The sound source signals OS1 and OS2 according to an embodiment of the present disclosure can include one or more of a first sound source signal OS1 corresponding to a second image (or an entertainment image) which is to be displayed by the second display part DA2 of the display apparatus 50 and a second sound source signal OS2 corresponding to a third image (or a navigation image) which is to be displayed by the third display part DA3 of the display apparatus 50.

The control circuit 300 according to an embodiment of the present disclosure can be configured to control a viewing angle mode of the display apparatus 50 and control the speaker driving circuit 200, based on the viewing angle mode of the display apparatus 50 selected by a driver 1 or a passenger 2.

According to an embodiment of the present disclosure, when the driver 1 and passengers 2 to 4 of a vehicular apparatus select a first viewing angle mode on the second image which is to be displayed by the second display part DA2 of the display apparatus 50, the control circuit 300 can be configured to generate a first viewing angle control signal VCS1 and a first sound mode signal SMS1 corresponding to the first viewing angle control signal VCS1. For example, each of the first viewing angle control signal VCS1 and the first sound mode signal SMS1 can have a first voltage level, a first logic level, or a high logic level, but embodiments of the present disclosure are not limited thereto. For example, the first viewing angle control signal VCS1 can be a share image mode signal, but embodiments of the present disclosure are not limited thereto. For example, the first sound mode signal SMS1 can be a share sound mode signal, but embodiments of the present disclosure are not limited thereto.

According to an embodiment of the present disclosure, when the driver 1 and passengers 2 to 4 of the vehicular apparatus select a second viewing angle mode on the second image which is to be displayed by the second display part DA2 of the display apparatus 50, the control circuit 300 can be configured to generate a second viewing angle control signal VCS2 and a second sound mode signal SMS2 corresponding to the second viewing angle control signal VCS2. For example, each of the second viewing angle control signal VCS2 and the second sound mode signal SMS2 can have a second voltage level, a second logic level, or a low logic level. For example, the second viewing angle control signal VCS2 can be a privacy image mode signal, but embodiments of the present disclosure are not limited thereto. For example, the second sound mode signal SMS2 can be a privacy sound mode signal, but embodiments of the present disclosure are not limited thereto.

According to an embodiment of the present disclosure, the control circuit 300 can be configured to control the display apparatus 50 to the first viewing angle mode or the second viewing angle mode, based on a viewing angle control signal VCS corresponding to a viewing angle mode selected by the driver 1 and passengers 2 to 4 of the vehicular apparatus. For example, the control circuit 300 can control the second display part DA2 of the display apparatus 50 to the first viewing angle mode, based on the first viewing angle control signal VCS1, or can control the second display part DA2 of the display apparatus 50 to the second viewing angle mode, based on the second viewing angle control signal VCS2.

The display apparatus 50 according to an embodiment of the present disclosure can be configured to receive the image signal Idata and the viewing angle control signal VCS supplied from the control circuit 300. Based on the viewing angle control signal VCS, the display apparatus 50 can switch a viewing angle mode of each of a plurality of subpixels SP configured in the display part DA and can display an image corresponding to the image signal Idata in a viewing angle mode corresponding to the viewing angle control signal VCS.

According to an embodiment of the present disclosure, for example, the plurality of subpixels SP configured in the second display part DA2 of the display apparatus 50 can be driven in the first viewing angle mode and can display a second image corresponding to a second image signal of the image signal Idata, based on the first viewing angle control signal VCS1. For example, the plurality of subpixels SP configured in the second display part DA2 of the display apparatus 50 can be driven in the second viewing angle mode and can display the second image corresponding to the second image signal of the image signal Idata, based on the second viewing angle control signal VCS2. For example, the plurality of subpixels SP configured in the third display part DA3 of the display apparatus 50 can be driven in the first viewing angle mode and can display a third image corresponding to a third image signal of the image signal Idata, based on the first viewing angle control signal VCS1.

The control circuit 300 according to an embodiment of the present disclosure can control the speaker driving circuit 200 to a first sound mode, based on the first viewing angle mode of the plurality of subpixels SP in the second display part DA2 of the display apparatus 50, and can control the speaker driving circuit 200 to a second sound mode, based on the second viewing angle mode of the plurality of subpixels SP in the second display part DA2 of the display apparatus 50.

According to an embodiment of the present disclosure, the control circuit 300 can be configured to control the speaker driving circuit 200 to the first sound mode or the second sound mode based on the sound mode signal SMS. For example, the control circuit 300 can be configured to control the speaker driving circuit 200 to the first sound mode, based on the first sound mode signal SMS1, or can control the speaker driving circuit 200 to the second sound mode, based on the second sound mode signal SMS2. For example, the first sound mode signal SMS1 can be a signal which is a same as the first viewing angle control signal VCS1, and the second sound mode signal SMS2 can be a signal which is a same as the second viewing angle control signal VCS2.

The speaker driving circuit 200 can be configured to output first to third sound signals SS1, SS2, and SS3 based on the first sound source signal OS1, the second sound source signal OS2, and the sound mode signal SMS supplied from the control circuit 300. For example, the speaker driving circuit 200 can be configured to selectively output the first and second sound signals SS1 and SS2 based on the sound mode signal SMS. For example, the speaker driving circuit 200 can be configured to output only a first sound signal SS1 of the first and second sound signals SS1 and SS2 based on the first sound source signal OS1 according to a first sound mode corresponding to the first sound mode signal SMS1. For example, the speaker driving circuit 200 can be configured to output all of the first and second sound signals SS1 and SS2 based on the first sound source signal OS1 according to a second sound mode corresponding to the second sound mode signal SMS2. For example, when the second sound source signal OS2 is supplied from the control circuit 300, the speaker driving circuit 200 can be configured to output the third sound signal SS3 based on the second sound source signal OS2.

The speaker driving circuit 200 according to an embodiment of the present disclosure can include a sound source receiver 210 and a sound signal generator 230.

The sound source receiver 210 can be configured to receive the first sound source signal OS1 and the second sound source signal OS2 supplied from the control circuit 300 to supply the first sound source signal OS1 and the second sound source signal OS2 to the sound signal generator 230.

The sound signal generator 230 can be configured to selectively output the first sound signal SS1 and the second sound signal SS2 based on the first sound source signal OS1, based on the first sound source signal OS1 supplied from the sound source receiver 210 and the sound mode signal SMS supplied from the control circuit 300. For example, the sound signal generator 230 can be configured to output only a first sound signal SS1 of the first and second sound signals SS1 and SS2 based on the first sound source signal OS1 according to the first sound mode corresponding to the first sound mode signal SMS1. For example, the sound signal generator 230 can be configured to output all of the first and second sound signals SS1 and SS2 based on the first sound source signal OS1 according to the second sound mode corresponding to the second sound mode signal SMS2.

The sound signal generator 230 can be configured to output the third sound signal SS3 based on the second sound source signal OS2 supplied from the sound source receiver 210. For example, when the second sound source signal OS2 is supplied from the sound source receiver 210, the sound signal generator 230 can be configured to output the third sound signal SS3 based on the second sound source signal OS2.

The sound signal generator 230 according to an embodiment of the present disclosure can include a signal processing circuit 231, a first amplifier circuit 232, a phase modulation circuit 233, a second amplifier circuit 234, an amplitude modulation circuit 235, and a third amplifier circuit 236.

Each of the signal processing circuit 231, the first amplifier circuit 232, the phase modulation circuit 233, the second amplifier circuit 234, the amplitude modulation circuit 235, and the third amplifier circuit 236 can be a same or substantially a same as that of each of the signal processing circuit 231, the first amplifier circuit 232, the phase modulation circuit 233, the second amplifier circuit 234, the amplitude modulation circuit 235, and the third amplifier circuit 236 described above with reference to FIG. 4, and thus, like reference numerals refer to like elements and its repeated descriptions are omitted or will be briefly given below. Therefore, the descriptions of each of the signal processing circuit 231, the first amplifier circuit 232, the phase modulation circuit 233, the second amplifier circuit 234, the amplitude modulation circuit 235, and the third amplifier circuit 235 described above with reference to FIG. 4 can be included in descriptions of FIG. 8.

The sound signal generator 230 according to an embodiment of the present disclosure can further include a phase-locked loop (or a phase synchronization circuit) 237.

The phase-locked loop 237 can be configured to synchronize a phase of the first sound signal SS1, supplied from the first amplifier circuit 232, with a phase of the second sound signal SS2 supplied from the second amplifier circuit 234. The phase-locked loop 237 can be a same or substantially a same as that of the phase-locked loop 237 described above with reference to FIG. 4, and thus, like reference numerals refer to like elements and its repeated descriptions are omitted or will be briefly given below. Therefore, the descriptions of the phase-locked loop 237 described above with reference to FIG. 4 can be included in descriptions of FIG. 8.

The sound signal generator 230 according to an embodiment of the present disclosure can further include a signal output part 238.

The signal output part 238 can be configured to apply the third sound signal SS3 to the directional speaker 190 and can be configured to selectively apply the first sound signal SS1 to the first and third speakers 110 and 130 and selectively apply the second sound signal SS2 to the second speaker 120, based on the sound mode signal SMS supplied from the control circuit 300. Except for selectively applying the first sound signal SS1 and the second sound signal SS2 based on the sound mode signal SMS, the signal output part 238 can be a same or substantially a same as the signal output part 238 described above with reference to FIG. 4, and thus, its repeated descriptions are omitted or will be briefly given below.

According to an embodiment of the present disclosure, the signal output part 238 can be configured to apply the first sound signal SS1 to the first and third speakers 110 and 130, based on the first sound mode signal SMS1. For example, the signal output part 238 can be configured to apply the first sound signal SS1 to the first and third speakers 110 and 130 and block the second sound signal SS2 applied to the second speaker 120, based on the first sound mode signal SMS1.

According to an embodiment of the present disclosure, the signal output part 238 can be configured to apply the third sound signal SS3 to the directional speaker 190 and apply the first sound signal SS1 to each of the first and third speakers 110 and 130, based on the first sound mode signal SMS1. For example, the signal output part 238 can be configured to apply the third sound signal SS3 to the directional speaker 190, apply the first sound signal SS1 to each of the first and third speakers 110 and 130, and block the second sound signal SS2 applied to the second speaker 120, based on the first sound mode signal SMS1.

According to an embodiment of the present disclosure, the signal output part 238 can be configured to apply the first sound signal SS1 to the first, third, fourth, and fifth speakers 110, 130, 140, and 150, based on the first sound mode signal SMS1. For example, the signal output part 238 can be configured to apply the first sound signal SS1 to the first, third, fourth, and fifth speakers 110, 130, 140, and 150 and block the second sound signal SS2 applied to the second speaker 120, based on the first sound mode signal SMS1.

According to an embodiment of the present disclosure, the signal output part 238 can be configured to apply the third sound signal SS3 to the directional speaker 190 and apply the first sound signal SS1 to each of the first, third, fourth, and fifth speakers 110, 130, 140, and 150, based on the first sound mode signal SMS1. For example, the signal output part 238 can be configured to apply the third sound signal SS3 to the directional speaker 190, apply the first sound signal SS1 to each of the first, third, fourth, and fifth speakers 110, 130, 140, and 150, and moreover, can block the second sound signal SS2 applied to the second speaker 120, based on the first sound mode signal SMS1.

According to an embodiment of the present disclosure, the signal output part 238 can be configured to apply the third sound signal SS3 to the directional speaker 190, apply the first sound signal SS1 to each of the first, third, fourth, and fifth speakers 110, 130, 140, and 150, based on the first sound mode signal SMS1, and moreover, can apply the second sound signal SS2 synchronized with the first sound signal SS1 to one or more of the sixth and seventh speakers 160 and 170. For example, the signal output part 238 can be configured to apply the third sound signal SS3 to the directional speaker 190, apply the first sound signal SS1 to each of the first, third, fourth, and fifth speakers 110, 130, 140, and 150 according to the first sound mode signal SMS1, apply the second sound signal SS2 synchronized with the first sound signal SS1 to one or more of the sixth and seventh speakers 160 and 170, and moreover, can block the second sound signal SS2 applied to the second speaker 120.

According to an embodiment of the present disclosure, the signal output part 238 can be configured to apply the first sound signal SS1 to each of the first and third speakers 110 and 130, based on the second sound mode signal SMS2, and apply the second sound signal SS2 synchronized with the first sound signal SS1 to the second speaker 120.

According to an embodiment of the present disclosure, the signal output part 238 can be configured to apply the third sound signal SS3 to the directional speaker 190, apply the first sound signal SS1 to each of the first and third speakers 110 and 130, based on the second sound mode signal SMS2, and apply the second sound signal SS2 synchronized with the first sound signal SS1 to the second speaker 120.

According to an embodiment of the present disclosure, the signal output part 238 can be configured to apply the first sound signal SS1 to each of the first and third speakers 110 and 130, based on the second sound mode signal SMS2, apply the second sound signal SS2 synchronized with the first sound signal SS1 to the second speaker 120, and block the first sound signal SS1 applied to the fourth and fifth speakers 140 and 150.

According to an embodiment of the present disclosure, the signal output part 238 can be configured to apply the third sound signal SS3 to the directional speaker 190, apply the first sound signal SS1 to each of the first and third speakers 110 and 130, based on the second sound mode signal SMS2, apply the second sound signal SS2 synchronized with the first sound signal SS1 to the second speaker 120, and block the first sound signal SS1 applied to the fourth and fifth speakers 140 and 150.

According to an embodiment of the present disclosure, the signal output part 238 can apply the first sound signal SS1 to each of the first, third, fourth, and fifth speakers 110, 130, 140, and 150, based on the second sound mode signal SMS2, and moreover, can apply the second sound signal SS2 synchronized with the first sound signal SS1 to the second speaker 120 and can simultaneously apply the second sound signal SS2 to one or more of the sixth and seventh speakers 160 and 170.

According to an embodiment of the present disclosure, the signal output part 238 can be configured to apply the third sound signal SS3 to the directional speaker 190, apply the first sound signal SS1 to each of the first, third, fourth, and fifth speakers 110, 130, 140, and 150, based on the second sound mode signal SMS2, and moreover, can apply the second sound signal SS2 synchronized with the first sound signal SS1 to the second speaker 120 and can simultaneously apply the second sound signal SS2 to one or more of the sixth and seventh speakers 160 and 170.

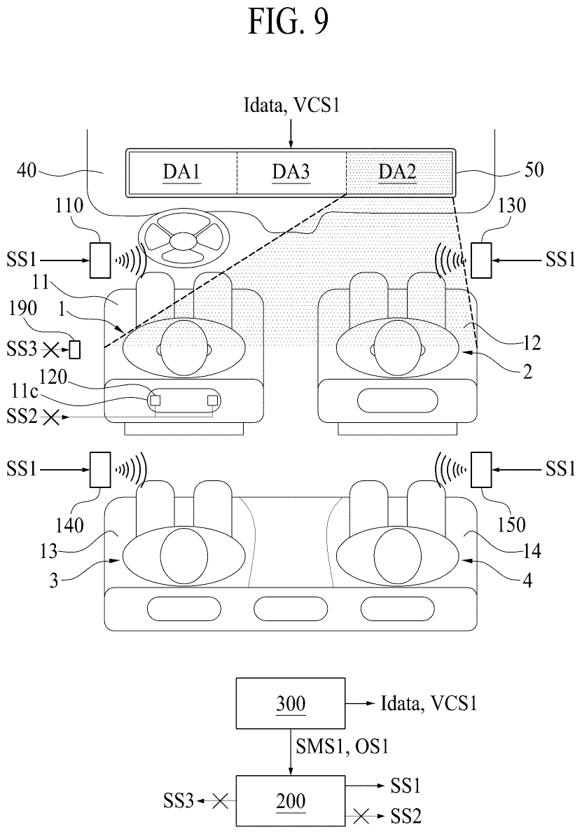

FIG. 9 illustrates a sound output system of a vehicular apparatus according to another embodiment of the present disclosure. For example, FIG. 9 is a diagram for describing a sound output system (or a sound output method) based on a first sound mode of a vehicular apparatus according to another embodiment of the present disclosure described above with reference to FIGS. 5 to 8.

Referring to FIG. 9, in the vehicular apparatus according to another embodiment of the present disclosure, the driver 1 and passengers 2 to 4 can select a first viewing angle mode on a second image which is to be displayed by a second display part DA2 of a display apparatus 50. A control circuit 300 can generate an image signal Idata and a first sound source signal OS1, based on an image source, and can generate the first viewing angle control signal VCS1 and a first sound mode signal SMS1, based on a first viewing angle mode of the second display part DA2.

The display apparatus 50 can display a second image signal of the image signal Idata in the first viewing angle mode on the second display part DA2, based on the first viewing angle control signal VCS1 supplied from the control circuit 300.

A speaker driving circuit 200 can generate a first sound signals SS1 and a second sound signals SS2 based on the first sound source signal OS1 supplied from the control circuit 300, can apply the first sound signal SS1 to first and third speakers 110 and 130, based on a first sound mode signal SMS1, and can block the second sound signal SS2 applied to a second speaker 120. For example, the speaker driving circuit 200 can be configured so that the second sound signal SS2 based on the first sound source signal OS1 is not generated based on the first sound mode signal SMS1.

The first speaker 110 can output a first sound corresponding to the first sound signal SS1 to a periphery of a driver seat 11 (or a driver 1), and the third speaker 130 can output the first sound corresponding to the first sound signal SS1 to a periphery of a passenger seat 12 (or a passenger 2). Accordingly, the driver 1 and the passenger 2 can listen to the first sound output through each of the first and third speakers 110 and 130 while watching the second image displayed on the second display part DA2 of the display apparatus 50 simultaneously, based on the first viewing angle mode.

The speaker driving circuit 200 can additionally apply the first sound signal SS1 to fourth and fifth speakers 140 and 150. The fourth speaker 140 can output the first sound corresponding to the first sound signal SS1 to a periphery of a first rear passenger seat 13 (or a first rear passenger 3), and the fifth speaker 150 can output the first sound corresponding to the first sound signal SS1 to a periphery of a second rear passenger seat 14 (or a second rear passenger 4). Accordingly, the first rear passenger 3 and the second rear passenger 4 can listen to the first sound output through each of the fourth and fifth speakers 140 and 150 while watching the second image displayed on the second display part DA2 of the display apparatus 50 simultaneously, based on the first viewing angle mode.

In the vehicular apparatus according to another embodiment of the present disclosure, because a second image is not displayed on the second display part DA2, the display apparatus 50 may not supply a second sound source signal OS2 to the control circuit 300, and thus, the speaker driving circuit 200 may not output a third sound signal SS3 based on the second sound source signal OS2.

The vehicular apparatus or the sound output system of the vehicular apparatus according to another embodiment of the present disclosure can provide all of the driver 1 and the passenger 2 with a sound and the second image displayed by the second display part DA2 of the display apparatus 50, based on the first viewing angle mode, and moreover, can additionally provide the sound and the second image to the first rear passenger 3 and the second rear passenger 4. Accordingly, the driver 1, the passenger 2, the first rear passenger 3, and the second rear passenger 4 can share the sound and the second image on the second display part DA2 of the display apparatus 50.

The sound output system (or sound output method) based on the first sound mode of the vehicular apparatus according to another embodiment of the present disclosure described above with reference to FIG. 9 can be applied when stopping or parking the vehicular apparatus, but embodiments of the present disclosure are not limited thereto.

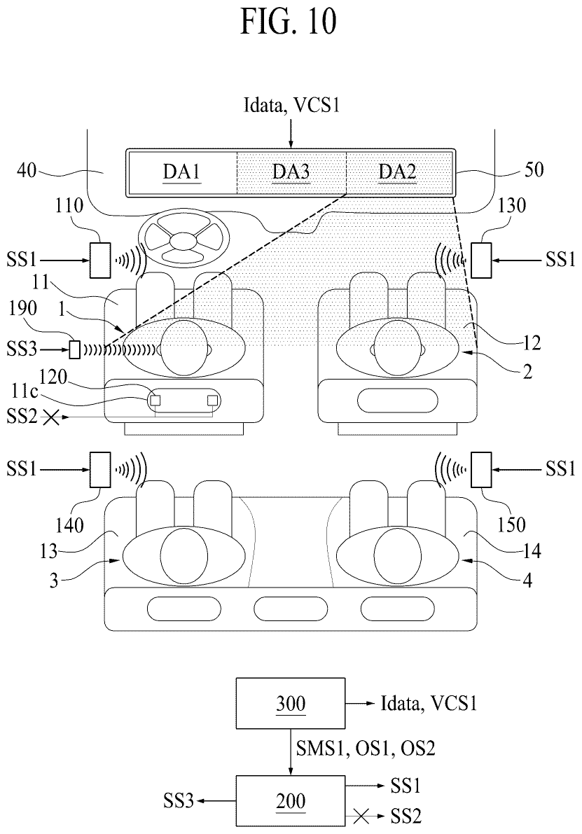

FIG. 10 illustrates a sound output system of a vehicular apparatus according to another embodiment of the present disclosure. For example, FIG. 10 is a diagram for describing a sound output system (or sound output method) based on a first sound mode of a vehicular apparatus according to another embodiment of the present disclosure described above with reference to FIGS. 5 to 8.

Referring to FIG. 10, in the vehicular apparatus according to another embodiment of the present disclosure, the driver 1 and passengers 2 to 4 can select a first viewing angle mode on a second image which is to be displayed by a second display part DA2 of a display apparatus 50. A control circuit 300 can generate an image signal Idata and a first sound source signal OS1, based on an image source, and can generate a first viewing angle control signal VCS1 and a first sound mode signal SMS1, based on the first viewing angle mode of the second display part DA2. The control circuit 300 can generate a second sound source signal OS2 based on a sound source supplied from a sound source supply device.

The display apparatus 50 can display a second image signal of an image signal Idata in the first viewing angle mode on a second display part DA2 and can display a third image signal of the image signal Idata in the first viewing angle mode on a third display part DA3, based on the first viewing angle control signal VCS1 supplied from the control circuit 300.

A speaker driving circuit 200 can generate a first sound signals SS1 and a second sound signals SS2 based on the first sound source signal OS1 supplied from the control circuit 300, can apply the first sound signal SS1 to first and third speakers 110 and 130, based on a first sound mode signal SMS1, and can block the second sound signal SS2 applied to a second speaker 120. For example, the speaker driving circuit 200 can be configured so that the second sound signal SS2 based on the first sound source signal OS1 is not generated based on the first sound mode signal SMS1.

The speaker driving circuit 200 can generate a third sound signal SS3 based on a second sound source signal OS2 supplied from the control circuit 300 and can apply the third sound signal SS3 to a directional speaker 190.

The first speaker 110 can output a first sound corresponding to the first sound signal SS1 to a periphery of a driver seat 11 (or a driver 1), and the third speaker 130 can output the first sound corresponding to the first sound signal SS1 to a periphery of a passenger seat 12 (or a passenger 2). Accordingly, the driver 1 and the passenger 2 can listen to the first sound output through each of the first and third speakers 110 and 130 while watching the second image displayed on the second display part DA2 of the display apparatus 50 simultaneously, based on the first viewing angle mode.

The directional speaker 190 can output a third sound corresponding to the third sound signal SS3 to the driver seat 11 (or the driver 1). Therefore, the driver 1 can listen to a first sound output through a first speaker 110 while watching a second image displayed on the second display part DA2 of the display apparatus 50 and can listen to navigation information corresponding to the third sound output through the directional speaker 190, based on the first viewing angle mode. Accordingly, the driver 1, a passenger 2, a first rear passenger 3, and a second rear passenger 4 can share a sound and a second image on the second display part DA2 of the display apparatus 50, and the driver 1 can additionally listen to the navigation information.

The sound output system (or sound output method) based on the first sound mode of the vehicular apparatus according to another embodiment of the present disclosure described above with reference to FIG. 10 can be applied when the vehicular apparatus is self-driving, but embodiments of the present disclosure are not limited thereto.

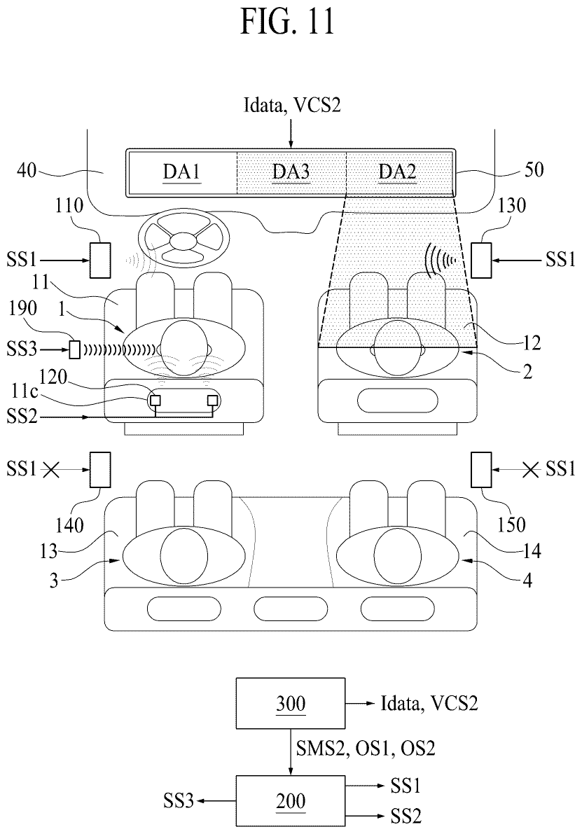

FIG. 11 illustrates a sound output system of a vehicular apparatus according to another embodiment of the present disclosure. For example, FIG. 11 is a diagram for describing a sound output system (or sound output method) based on a second sound mode of a vehicular apparatus according to another embodiment of the present disclosure described above with reference to FIGS. 5 to 8.

Referring to FIG. 11, in the vehicular apparatus according to another embodiment of the present disclosure, the driver 1 and passengers 2 to 4 can select a second viewing angle mode on a second image which is to be displayed by a second display part DA2 of a display apparatus 50. A control circuit 300 can generate an image signal Idata and a first sound source signal OS1, based on an image source, and can generate a second viewing angle control signal VCS2 and a second sound mode signal SMS2, based on the second viewing angle mode of a second display part DA2. The control circuit 300 can generate a second sound source signal OS2 based on a sound source supplied from a sound source supply device.

The display apparatus 50 can display a second image signal of an image signal Idata in the second viewing angle mode on a second display part DA2 and can display a third image signal of the image signal Idata in the first viewing angle mode or the second viewing angle mode on a third display part DA3, based on the second viewing angle control signal VCS2 supplied from the control circuit 300.

A speaker driving circuit 200 can generate a first sound signal SS1 and a second sound signal SS2 based on the first sound source signal OS1 supplied from the control circuit 300, can apply the first sound signal SS1 to first and third speakers 110 and 130, based on the second sound mode signal SMS2, and can apply the second sound signal SS2 synchronized with the first sound signal SS1 to a second speaker 120. Moreover, the speaker driving circuit 200 can apply a third sound signal SS3 to a directional speaker 190, based on the second sound source signal OS2 supplied from the control circuit 300.

The first speaker 110 can output a first sound corresponding to the first sound signal SS1 to a periphery of a driver seat 11 (or a driver 1), the second speaker 120 can output a second sound corresponding to the second sound signal SS2 to the periphery of the driver seat 11 (or the driver 1), and the third speaker 130 can output the first sound corresponding to the first sound signal SS1 to a periphery of a passenger seat 12 (or a passenger 2). The directional speaker 190 can output a third sound corresponding to the third sound signal SS3 to the periphery of the driver seat 11 (or the driver 1).

Therefore, the driver 1 may not watch a second image displayed on the second display part DA2 of the display apparatus 50, based on the second viewing angle mode, may not listen to the first sound corresponding to the second image displayed on the second display part DA2 due to destructive interference between the first sound output from the first speaker 110 and the second sound output from the second speaker 120, and can listen to navigation information corresponding to a third sound output through the directional speaker 190, and thus, can concentrate in driving without being interrupted by the first sound. The passenger 2 can watch a second image displayed on the second display part DA2 of the display apparatus 50 and can listen to the first sound output through the third speaker 130, based on the second viewing angle mode. For example, the passenger 2 can individually (or independently) enjoy the first sound and the second image displayed on the second display part DA2 of the display apparatus 50, based on the second viewing angle mode.

According to another embodiment of the present disclosure, the speaker driving circuit 200 can block the first sound signal SS1 applied to fourth and fifth speakers 140 and 150. Accordingly, based on a selection of the passenger 2, a sound corresponding to the second image displayed on the second display part DA2 of the display apparatus 50 in the second viewing angle mode may not be provided (or share) to a first rear passenger 3 and a second rear passenger 4.

According to another embodiment of the present disclosure, the speaker driving circuit 200 can be configured to apply the first sound signal SS1 to only the third speaker 130, based on the second sound mode signal SMS2, can apply the second sound signal SS2 synchronized with the first sound signal SS1 to the second speaker 120, and can apply the third sound signal SS3 to the directional speaker 190. For example, in the second sound mode signal SMS2, the first sound signal SS1 can apply to only the third speaker 130 of the first, third, fourth, and fifth speakers 110, 130, 140, and 150. For example, in the second sound mode signal SMS2, the speaker driving circuit 200 can block the first sound signal SS1 applied to the first, fourth, and fifth speakers 110, 140, and 150, Accordingly, based on a selection of the passenger 2, a sound corresponding to the second image displayed on the second display part DA2 of the display apparatus 50 in the second viewing angle mode may not be provided (or share) to the driver 1, the first rear passenger 3, and the second rear passenger 4.

The vehicular apparatus or the sound output system of the vehicular apparatus according to another embodiment of the present disclosure can provide only the passenger 2 with a sound and the second image displayed on the second display part DA2 of the display apparatus 50, based on the second viewing angle mode. Accordingly, the driver 1 can concentrate in driving without being interrupted by the sound and the second image displayed on the second display part DA2 of the display apparatus 50.

The sound output system (or sound output method) based on the second sound mode of the vehicular apparatus according to another embodiment of the present disclosure described above with reference to FIG. 11 can be applied when the vehicular apparatus is being driven by the driver, but embodiments of the present disclosure are not limited thereto.

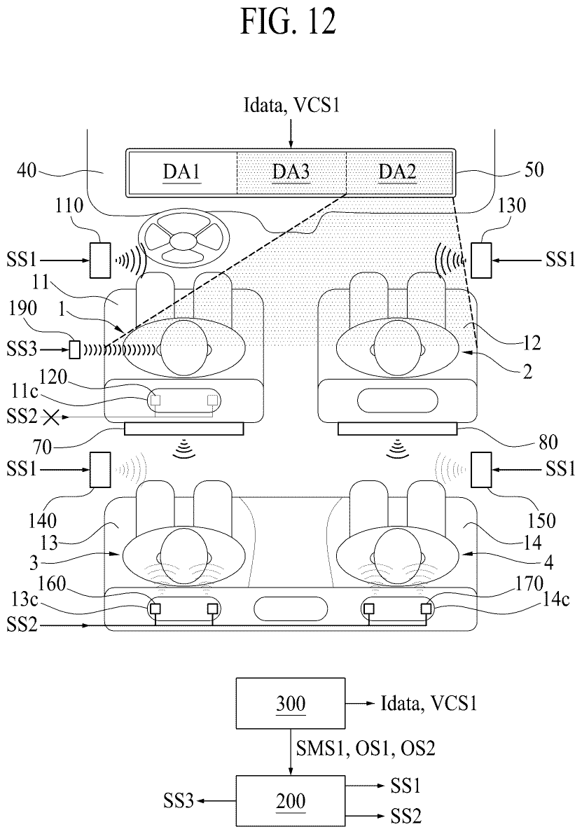

FIG. 12 illustrates a sound output system of a vehicular apparatus according to another embodiment of the present disclosure. For example, FIG. 12 is a diagram for describing a sound output system (or sound output method) based on a first sound mode of a vehicular apparatus according to another embodiment of the present disclosure described above with reference to FIGS. 5 to 8.

Referring to FIG. 12, in the vehicular apparatus according to another embodiment of the present disclosure, the driver 1 and passengers 2 to 4 can select a first viewing angle mode on a second image which is to be displayed by a second display part DA2 of a display apparatus 50. A control circuit 300 can generate an image signal Idata and a first sound source signal OS1, based on an image source, and can generate a first viewing angle control signal VCS1 and a first sound mode signal SMS1, based on the first viewing angle mode of a second display part DA2. The control circuit 300 can generate a second sound source signal OS2 based on a sound source supplied from a sound source supply device.

The display apparatus 50 can display a second image signal of an image signal Idata in the first viewing angle mode on a second display part DA2 and can display a third image signal of the image signal Idata in the first viewing angle mode on a third display part DA3, based on the first viewing angle control signal VCS1 supplied from the control circuit 300.

A speaker driving circuit 200 can generate a first sound signal SS1 and a second sound signal SS2 based on the first sound source signal OS1 supplied from the control circuit 300, can apply the first sound signal SS1 to first and third speakers 110 and 130, based on a first sound mode signal SMS1, and can block the second sound signal SS2 applied to a second speaker 120. Moreover, the speaker driving circuit 200 can apply a third sound signal SS3 to a directional speaker 190, apply the first sound signal SS1 to fourth and fifth speakers 140 and 150, and apply the second sound signal SS2 to sixth and seventh speakers 160 and 170, based on the second sound source signal OS2 supplied from the control circuit 300.

The first speaker 110 can output a first sound corresponding to the first sound signal SS1 to a periphery of a driver seat 11 (or a driver 1), and the third speaker 130 can output the first sound corresponding to the first sound signal SS1 to a periphery of a passenger seat 12 (or a passenger 2). The directional speaker 190 can output a third sound corresponding to the third sound signal SS3 to the periphery of the driver seat 11 (or the driver 1). Therefore, the driver 1 can listen to the first sound output through the first speaker 110 while watching a second image displayed on the second display part DA2 of the display apparatus 50 and can listen to navigation information corresponding to the third sound output through the directional speaker 190, based on the first viewing angle mode. Accordingly, the driver 1 and the passenger 2 can share a sound and a second image on the second display part DA2 of the display apparatus 50, and the driver 1 can additionally listen to the navigation information.

The fourth speaker 140 can output the first sound corresponding to the first sound signal SS1 to a periphery of a first rear passenger seat 13 (or a first rear passenger 3), and the fifth speaker 150 can output the first sound corresponding to the first sound signal SS1 to a periphery of a second rear passenger seat 14 (or a second rear passenger 4). The sixth speaker 160 can output a second sound corresponding to the second sound signal SS2 to the periphery of the first rear passenger seat 13 (or the first rear passenger 3), and the seventh speaker 170 can output the second sound corresponding to the second sound signal SS2 to the periphery of the second rear passenger seat 14 (or the second rear passenger 4). Accordingly, the first rear passenger 3 may not listen to the first sound corresponding to the second image displayed on the second display part DA2 due to destructive interference between the first sound output from the fourth speaker 140 and the second sound output from the sixth speaker 160. The second rear passenger 4 may not listen to the first sound corresponding to the second image displayed on the second display part DA2 due to destructive interference between the first sound output from the fifth speaker 150 and the second sound output from the seventh speaker 170.

The first rear passenger 3 can perform office tasks (or private works) by using a first auxiliary display apparatus 70 or can have a deep sleep without being interrupted by the first sound output from the fourth speaker 140. For example, the first rear passenger 3 can enjoy an individual image and an individual sound through the first auxiliary display apparatus 70 including its own speaker.

The second rear passenger 4 can perform office tasks (or private works) by using a second auxiliary display apparatus 80 or can have a deep sleep without being interrupted by the first sound output from the fifth speaker 150. For example, the second rear passenger 4 can enjoy an individual image and an individual sound through the second auxiliary display apparatus 80 including its own speaker.

The sound output system (or sound output method) based on the first sound mode of the vehicular apparatus according to another embodiment of the present disclosure described above with reference to FIG. 12 can be applied when the vehicular apparatus is self-driving, but embodiments of the present disclosure are not limited thereto.

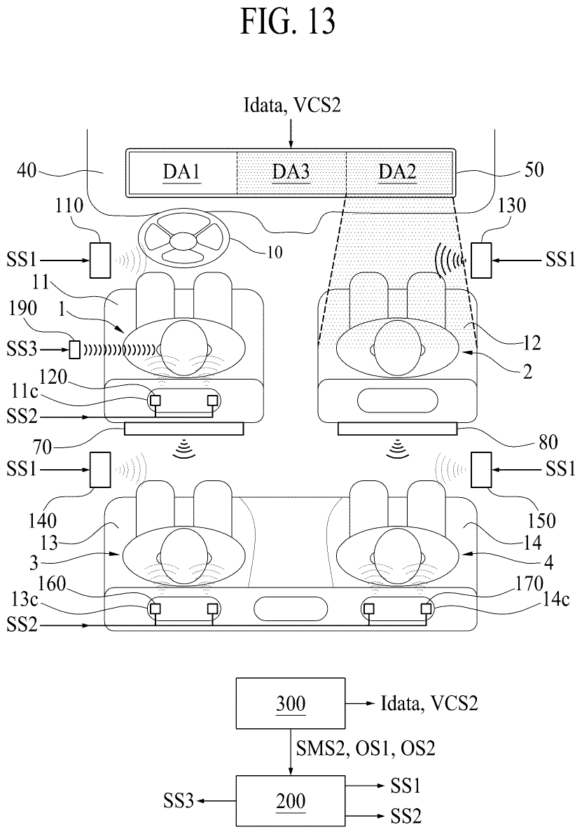

FIG. 13 illustrates a sound output system of a vehicular apparatus according to another embodiment of the present disclosure. For example, FIG. 13 is a diagram for describing a sound output system (or sound output method) based on a second sound mode of a vehicular apparatus according to another embodiment of the present disclosure described above with reference to FIGS. 5 to 8.

Referring to FIG. 13, in the vehicular apparatus according to another embodiment of the present disclosure, the driver 1 and passengers 2 to 4 can select a second viewing angle mode on a second image which is to be displayed by a second display part DA2 of a display apparatus 50. A control circuit 300 can generate an image signal Idata and a first sound source signal OS1, based on an image source, and can generate a second viewing angle control signal VCS2 and a second sound mode signal SMS2, based on the second viewing angle mode of a second display part DA2. The control circuit 300 can generate a second sound source signal OS2 based on a sound source supplied from a sound source supply device.

The display apparatus 50 can display a second image signal of an image signal Idata in the second viewing angle mode on a second display part DA2 and can display a third image signal of the image signal Idata in the first viewing angle mode or the second viewing angle mode on a third display part DA3, based on the second viewing angle control signal VCS2 supplied from the control circuit 300.

A speaker driving circuit 200 can generate a first sound signal SS1 and a second sound signal SS2 based on the first sound source signal OS1 supplied from the control circuit 300, can apply the first sound signal SS1 to first and third speakers 110 and 130, based on the second sound mode signal SMS2, and can apply the second sound signal SS2 synchronized with the first sound signal SS1 to a second speaker 120. Moreover, the speaker driving circuit 200 can apply a third sound signal SS3 to a directional speaker 190, apply the first sound signal SS1 to fourth and fifth speakers 140 and 150, and apply the second sound signal SS2 to sixth and seventh speakers 160 and 170, based on the second sound source signal OS2 supplied from the control circuit 300.

The first speaker 110 can output a first sound corresponding to the first sound signal SS1 to a periphery of a driver seat 11 (or a driver 1), the second speaker 120 can output a second sound corresponding to the second sound signal SS2 to the periphery of the driver seat 11 (or the driver 1), and the third speaker 130 can output the first sound corresponding to the first sound signal SS1 to a periphery of a passenger seat 12 (or a passenger 2). The directional speaker 190 can output a third sound corresponding to the third sound signal SS3 to the periphery of the driver seat 11 (or the driver 1). Therefore, the driver 1 may not watch a second image displayed on the second display part DA2 of the display apparatus 50, based on the second viewing angle mode, may not listen to the first sound corresponding to the second image displayed on the second display part DA2 due to destructive interference between the first sound output from the first speaker 110 and the second sound output from the second speaker 120, and can listen to navigation information corresponding to a third sound output through the directional speaker 190, and thus, can concentrate in driving without being interrupted by the first sound. The passenger 2 can watch a second image displayed on the second display part DA2 of the display apparatus 50 and can listen to the first sound output through the third speaker 130, based on the second viewing angle mode. For example, the passenger 2 can individually (or independently) enjoy the first sound and the second image displayed on the second display part DA2 of the display apparatus 50, based on the second viewing angle mode.

The fourth speaker 140 can output the first sound corresponding to the first sound signal SS1 to a periphery of a first rear passenger seat 13 (or a first rear passenger 3), and the fifth speaker 150 can output the first sound corresponding to the first sound signal SS1 to a periphery of a second rear passenger seat 14 (or a second rear passenger 4). The sixth speaker 160 can output the second sound corresponding to the second sound signal SS2 to the periphery of the first rear passenger seat 13 (or the first rear passenger 3), and the seventh speaker 170 can output the second sound corresponding to the second sound signal SS2 to the periphery of the second rear passenger seat 14 (or the second rear passenger 4). Accordingly, the first rear passenger 3 may not listen to the first sound corresponding to the second image displayed on the second display part DA2 due to destructive interference between the first sound output from the fourth speaker 140 and the second sound output from the sixth speaker 160. The second rear passenger 4 may not listen to the first sound corresponding to the second image displayed on the second display part DA2 due to destructive interference between the first sound output from the fifth speaker 150 and the second sound output from the seventh speaker 170.

The first rear passenger 3 can perform office tasks (or private works) by using a first auxiliary display apparatus 70 or can have a deep sleep without being interrupted by the first sound output from the fourth speaker 140. For example, the first rear passenger 3 can enjoy an individual image and an individual sound through the first auxiliary display apparatus 70 including its own speaker.

The second rear passenger 4 can perform office tasks (or private works) by using a second auxiliary display apparatus 80 or can have a deep sleep without being interrupted by the first sound output from the fifth speaker 150. For example, the second rear passenger 4 can enjoy an individual image and an individual sound through the second auxiliary display apparatus 80 including its own speaker.

The sound output system (or sound output method) based on the second sound mode of the vehicular apparatus according to another embodiment of the present disclosure described above with reference to FIG. 13 can be applied when the vehicular apparatus is being driven by the driver, but embodiments of the present disclosure are not limited thereto.

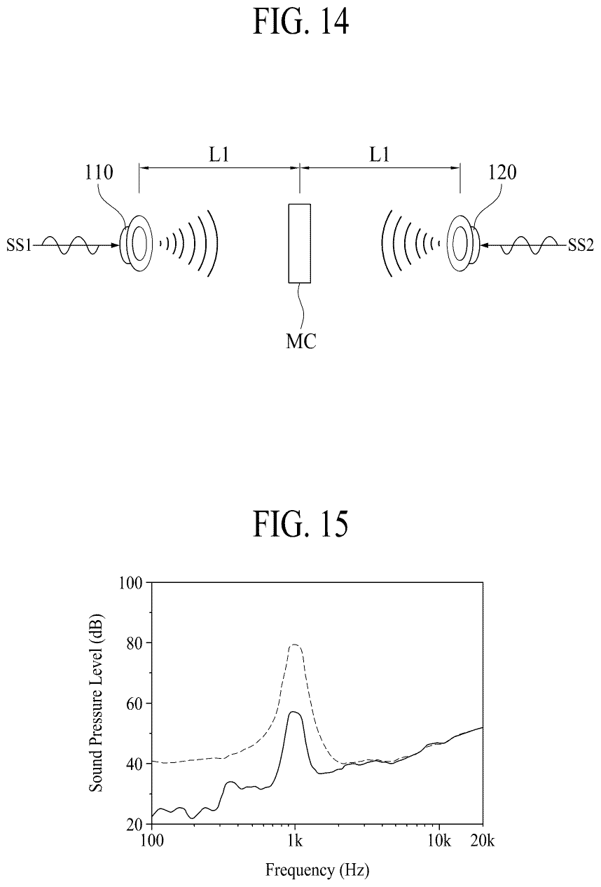

FIG. 14 is a schematic diagram of an experimental example for measuring a sound canceling effect of a vehicular apparatus according to an embodiment of the present disclosure. FIG. 15 illustrates a frequency-based sound pressure level in a case where a distance between a microphone device and each of a first speaker and a second speaker illustrated in FIG. 14 is 5 cm.

Referring to FIG. 14, in the experimental example of the present disclosure, a distance L1 between a microphone device MC and each of a first speaker 110 and a second speaker 120 has been adjusted to 5 cm, 10 cm, 20 cm, and 30 cm, a sound output from each of the first speaker 110 and the second speaker 120 has been collected through the microphone device MC, and a frequency-based sound pressure level has been measured.

The microphone device MC can be disposed between the first and second speakers 110 and 120 disposed in parallel. The distances L1 between the microphone device MC and the first speaker 110 and the second speaker 120 can be adjusted to be equal to each other. The first speaker 110 can be driven based on a first sound signal SS1 having an in-phase to output a first sound, and the second speaker 120 can be driven based on a second sound signal SS2 having an anti-phase to output a second sound.

In FIG. 15, a dotted line represents a frequency-based sound pressure level of a first sound output from the first speaker 110, and a solid line represents a frequency-based sound pressure level based on a sound pressure canceling effect of the first sound output from the first speaker 110 and a second sound output from the second speaker 120.

As seen in FIG. 15, when a distance between a microphone device and each of a first speaker and a second speaker is 5 cm, it can be seen that a sound pressure canceling effect increases in a pitched sound band of about 1 kHz. For example, it has been measured that a sound pressure level decreases by about 22 dB in a pitched sound band of about 1 kHz, based on the sound pressure canceling effect.

In an experiment, when the distance L1 between the microphone device MC and each of the first speaker 110 and the second speaker 120 is 10 cm, it has been measured that a sound pressure level decreases by about 17.4 dB in a pitched sound band of about 1 kHz.

In an experiment, when the distance L1 between the microphone device MC and each of the first speaker 110 and the second speaker 120 is 20 cm, it has been measured that a sound pressure level decreases by about 17.1 dB in a pitched sound band of about 1 kHz.

In an experiment, when the distance L1 between the microphone device MC and each of the first speaker 110 and the second speaker 120 is 30 cm, it has been measured that a sound pressure level decreases by about 14.1 dB in a pitched sound band of about 1 kHz.

Therefore, the first speaker 110 and the second speaker 120 can be at a same distance from the microphone device MC, and the sound pressure canceling effect can be maximized as a distance from the microphone device MC decreases progressively up to 5 cm from 30 cm.

Accordingly, in the vehicular apparatus according to an embodiment of the present disclosure, a distance between a driver and each of the first speaker 110 and the second speaker 120 can be adjusted to 30 cm or less, so as to maximize the sound pressure canceling effect.

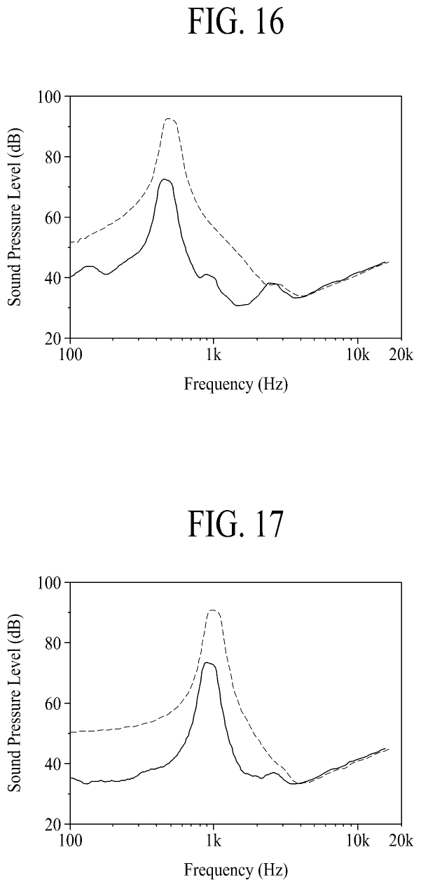

FIG. 16 illustrates a frequency-based sound pressure level characteristic of a sound source of 500 Hz, in a case where a distance between the microphone device and each of the first speaker and the second speaker illustrated in FIG. 14 is 10 cm.

In FIG. 16, a dotted line represents a frequency-based sound pressure level of a first sound output from the first speaker 110, and a solid line represents a frequency-based sound pressure level based on a sound pressure canceling effect of the first sound output from the first speaker 110 and a second sound output from the second speaker 120.

As seen in FIG. 16, when a distance between a microphone device and each of a first speaker and a second speaker is 10 cm and a sound source is 500 Hz, it can be seen that the sound pressure canceling effect increases in a pitched sound band of about 500 Hz. For example, it has been measured that a sound pressure level decreases by about 20.1 dB in a pitched sound band of about 500 Hz, based on the sound pressure canceling effect.

FIG. 17 illustrates a frequency-based sound pressure level characteristic of a sound source of 1 kHz, in a case where a distance between the microphone device and each of the first speaker and the second speaker illustrated in FIG. 14 is 10 cm.

In FIG. 17, a dotted line represents a frequency-based sound pressure level of a first sound output from the first speaker 110, and a solid line represents a frequency-based sound pressure level based on a sound pressure canceling effect of the first sound output from the first speaker 110 and a second sound output from the second speaker 120.

As seen in FIG. 17, when a distance between a microphone device and each of a first speaker and a second speaker is 10 cm and a sound source is 1 kHz, it can be seen that the sound pressure canceling effect increases in a pitched sound band of about 1 kHz. For example, it has been measured that a sound pressure level decreases by about 17.4 dB in a pitched sound band of about 1 kHz, based on the sound pressure canceling effect.

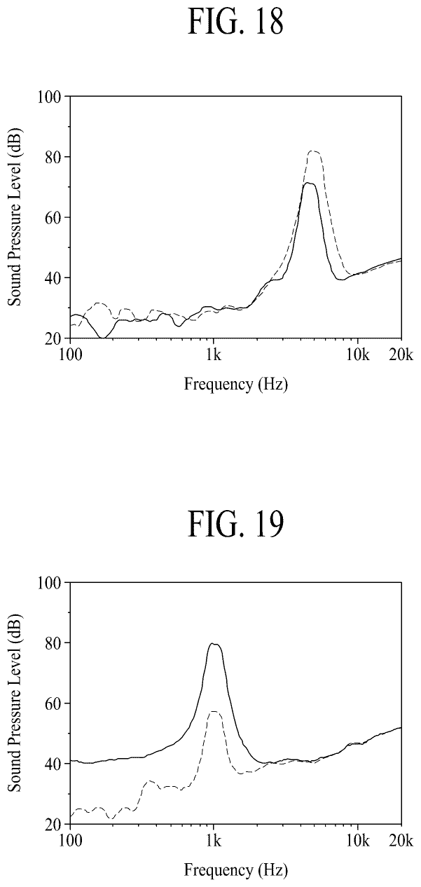

FIG. 18 illustrates a frequency-based sound pressure level characteristic of a sound source of 5 kHz, in a case where a distance between the microphone device and each of the first speaker and the second speaker illustrated in FIG. 14 is 10 cm.

In FIG. 18, a dotted line represents a frequency-based sound pressure level of a first sound output from the first speaker 110, and a solid line represents a frequency-based sound pressure level based on a sound pressure canceling effect of the first sound output from the first speaker 110 and a second sound output from the second speaker 120.

As seen in FIG. 18, when a distance between a microphone device and each of a first speaker and a second speaker is 10 cm and a sound source is 5 kHz, it can be seen that the sound pressure canceling effect increases in a pitched sound band of about 5 kHz. For example, it has been measured that a sound pressure level decreases by about 9.7 dB in a pitched sound band of about 5 kHz, based on the sound pressure canceling effect.

As seen in FIGS. 16 to 18, in a low pitched sound band of 1 kHz or less, four or more times sound pressure canceling effect can be realized. Two or more times sound pressure canceling effect can be realized toward a high pitched sound band of 5 kHz or more. For example, referring to FIG. 16, because there is a difference of about 20.1 dB in 500 Hz, ten times sound pressure canceling effect can be realized. For example, referring to FIG. 17, because there is a difference of about 17.4 dB in 1 kHz or less, seven times sound pressure canceling effect can be realized. For example, referring to FIG. 18, because there is a difference of about 9.7 dB in 5 kHz or more, two times sound pressure canceling effect can be realized.

Accordingly, the vehicular apparatus according to an embodiment of the present disclosure can block a sound which interrupts the safe driving of a driver, based on a sound pressure canceling effect in an audible frequency band.

FIG. 19 illustrates a frequency-based sound pressure level characteristic in a case where distances between a microphone device and a first speaker and a second speaker illustrated in FIG. 14 differ. For example, FIG. 19 illustrates a frequency-based sound pressure level characteristic in a case where a distance between the microphone device and the first speaker illustrated in FIG. 14 is 10 cm and a distance between the microphone device and the second speaker is 30 cm.

In FIG. 19, a dotted line represents a frequency-based sound pressure level of a first sound output from the first speaker 110, and a solid line represents a frequency-based sound pressure level based on a sound pressure canceling effect of the first sound output from the first speaker 110 and a second sound output from the second speaker 120.

As seen in FIG. 19, when the distance between the microphone device and the first speaker is 10 cm and the distance between the microphone device and the second speaker is 30 cm, it can be seen that the sound pressure canceling effect decreases in a pitched sound band of about 1 kHz. For example, it has been measured that a sound pressure level increases by about 13.6 dB in a pitched sound band of about 1 kHz, based on a reduction in sound pressure canceling effect.

In an experiment, when the distance between the microphone device and the first speaker is 10 cm and the distance between the microphone device and the second speaker is 20 cm, it has been measured that a sound pressure level increases by about 9.6 dB in a pitched sound band of about 1 kHz, based on an increase in sound pressure level by constructive interference.

In an experiment, when the distance between the microphone device and the first speaker is 10 cm and the distance between the microphone device and the second speaker is 5 cm, it has been measured that a sound pressure level increases by about 2.0 dB in a pitched sound band of about 1 kHz, based on a reduction in sound pressure canceling effect.

Accordingly, in the vehicular apparatus according to an embodiment of the present disclosure, when distances between a driver and the first speaker 110 and the second speaker 120 differ, the sound pressure canceling effect can decrease, and thus, the distances between the driver and the first speaker 110 and the second speaker 120 can be equally adjusted to 30 cm or less, so as to maximize the sound pressure canceling effect.

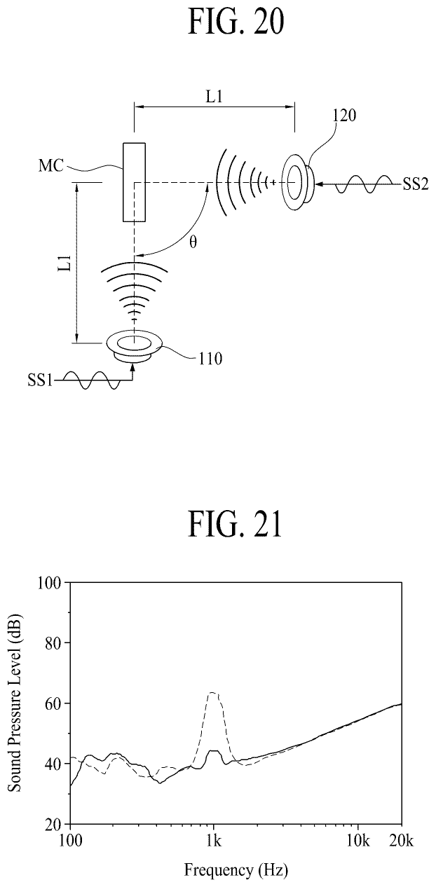

FIG. 20 is a schematic diagram of another experimental example for measuring a sound canceling effect of a vehicular apparatus according to an embodiment of the present disclosure. FIG. 21 illustrates a frequency-based sound pressure level in a case where an angle between a first speaker and a second speaker illustrated in FIG. 20 is 0 (zero) degrees.

Referring to FIG. 20, in the experimental example of the present disclosure, a distance L1 between a microphone device MC and each of a first speaker 110 and a second speaker 120 has been adjusted to 10 cm, an angle (θ) between the first speaker 110 and the second speaker 120 has been adjusted to 0 degrees, 30 degrees, 60 degrees, and 90 degrees (or 30-degree unit from 0 degrees to 90 degrees), a sound output from each of the first speaker 110 and the second speaker 120 has been collected through the microphone device MC, and a frequency-based sound pressure level has been measured.

The distances L1 between the microphone device MC and the first speaker 110 and the second speaker 120 can be adjusted to be equal to each other. The first speaker 110 can be driven based on a first sound signal SS1 having an in-phase to output a first sound, and the second speaker 120 can be driven based on a second sound signal SS2 having an anti-phase to output a second sound.

In FIG. 21, a dotted line represents a frequency-based sound pressure level of a first sound output from the first speaker 110, and a solid line represents a frequency-based sound pressure level based on a sound pressure canceling effect of the first sound output from the first speaker 110 and a second sound output from the second speaker 120.

As seen in FIG. 21, when an angle (θ) between the first speaker 110 and the second speaker 120 is 0 degrees, it can be seen that the sound pressure canceling effect increases in a pitched sound band of about 1 kHz. For example, it has been measured that a sound pressure level increases by about 18.8 dB in a pitched sound band of about 1 kHz, based on a reduction in sound pressure canceling effect.

In an experiment, when an angle (θ) between the first speaker 110 and the second speaker 120 is 30 degrees, it has been measured that a sound pressure level decreases by about 10.9 dB in a pitched sound band of about 1 kHz.

In an experiment, when an angle (θ) between the first speaker 110 and the second speaker 120 is 60 degrees, it has been measured that a sound pressure level decreases by about 6.7 dB in a pitched sound band of about 1 kHz.

In an experiment, when an angle (θ) between the first speaker 110 and the second speaker 120 is 90 degrees, it has been measured that a sound pressure level increases by about 1.9 dB in a pitched sound band of about 1 kHz.

Accordingly, when each of the first speaker 110 and the second speaker 120 is at a distance of 10 cm from the microphone MC and an angle (θ) between the first speaker 110 and the second speaker 120 is 60 degrees or less, the sound pressure canceling effect can be enhanced. For example, when the first speaker 110 and the second speaker 120 are at the same distance from the microphone MC and are disposed in parallel, the sound pressure canceling effect can be maximized.

Accordingly, in the vehicular apparatus according to an embodiment of the present disclosure, each of the first speaker 110 and the second speaker 120 can be disposed at the same distance from the driver 1, and an angle (θ) between the first speaker 110 and the second speaker 120 can be adjusted to 60 degrees or less.

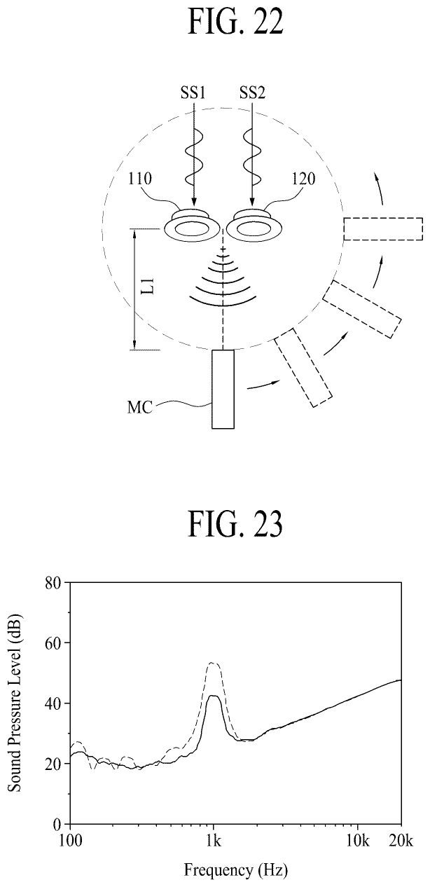

FIG. 22 is a schematic diagram of another experimental example for measuring a sound canceling effect of a vehicular apparatus according to an embodiment of the present disclosure. FIG. 23 illustrates a frequency-based sound pressure level in a case where an angle between a first speaker and a second speaker illustrated in FIG. 22 is 30 degrees.

Referring to FIG. 22, in the experimental example of the present disclosure, a distance L1 between a microphone device MC and each of a first speaker 110 and a second speaker 120 has been adjusted to 30 cm, an angle (θ) between the first speaker 110 and the second speaker 120 has been adjusted in 30-degree unit from 0 degrees to 180 degrees, a sound output from each of the first speaker 110 and the second speaker 120 has been collected through the microphone device MC, and a frequency-based sound pressure level has been measured.

The distances L1 between the microphone device MC and each of the first speaker 110 and the second speaker 120 can be adjusted to be equal to each other. The first speaker 110 can be driven based on a first sound signal SS1 having an in-phase to output a first sound, and the second speaker 120 can be driven based on a second sound signal SS2 having an anti-phase to output a second sound.

In FIG. 23, a dotted line represents a frequency-based sound pressure level of a first sound output from the first speaker 110, and a solid line represents a frequency-based sound pressure level based on a sound pressure canceling effect of the first sound output from the first speaker 110 and a second sound output from the second speaker 120.

As seen in FIG. 23, when an angle (θ) between the first speaker 110 and the second speaker 120 is 30 degrees, it can be seen that the sound pressure canceling effect increases in a pitched sound band of about 1 kHz. For example, it has been measured that a sound pressure level increases by about 10.6 dB in a pitched sound band of about 1 kHz, based on a reduction in sound pressure canceling effect.

In an experiment, when an angle (θ) between the first speaker 110 and the second speaker 120 is 0 degrees, it has been measured that a sound pressure level decreases by about 0.1 dB in a pitched sound band of about 1 kHz.

In an experiment, when an angle (θ) between the first speaker 110 and the second speaker 120 is 60 degrees, it has been measured that a sound pressure level decreases by about 9.1 dB in a pitched sound band of about 1 kHz.

In an experiment, when an angle (θ) between the first speaker 110 and the second speaker 120 is 90 degrees, it has been measured that a sound pressure level increases by about 1.3 dB in a pitched sound band of about 1 kHz.

In an experiment, when an angle (θ) between the first speaker 110 and the second speaker 120 is 120 degrees, it has been measured that a sound pressure level increases by about 5.3 dB in a pitched sound band of about 1 kHz.

In an experiment, when an angle (θ) between the first speaker 110 and the second speaker 120 is 150 degrees, it has been measured that a sound pressure level increases by about 3.7 dB in a pitched sound band of about 1 kHz.

In an experiment, when an angle (θ) between the first speaker 110 and the second speaker 120 is 180 degrees, it has been measured that a sound pressure level increases by about 5.7 dB in a pitched sound band of about 1 kHz.

Accordingly, when each of the first speaker 110 and the second speaker 120 is at a distance of 30 cm from the microphone MC and an angle (θ) between the first speaker 110 and the second speaker 120 is 90 degrees or less, the sound pressure canceling effect can be enhanced. For example, when the first speaker 110 and the second speaker 120 are at the same distance from the microphone MC and are disposed in parallel, the sound pressure canceling effect can be maximized.

Accordingly, in the vehicular apparatus according to an embodiment of the present disclosure, each of the first speaker 110 and the second speaker 120 can be disposed at the same distance from the driver 1, and an angle (θ) between the first speaker 110 and the second speaker 120 can be adjusted to 90 degrees or less.

The vehicular apparatus according to one or more embodiments of the present disclosure will be described below.

The vehicular apparatus according to one or more embodiments of the present disclosure can comprise a first speaker configured to output a first sound to a periphery of a driver seat based on a first sound signal, a second speaker configured to output a second sound to the periphery of the driver seat based on a second sound signal, and a speaker driving circuit configured to generate the first sound signal and the second sound signal based on a sound source. The second sound signal can have an anti-phase opposite to a phase of the first sound signal.

According to one or more embodiments of the present disclosure, each of the first speaker and the second speaker can comprise one or more sound apparatuses configured in a headrest of the driver seat.

According to one or more embodiments of the present disclosure, the first speaker can comprise a first sound apparatus at a first edge portion of the headrest and a second sound apparatus at a second edge portion of the headrest. The second speaker can comprise a first auxiliary sound apparatus at the first edge portion of the headrest and a second auxiliary sound apparatus at the second edge portion of the headrest.

According to one or more embodiments of the present disclosure, an angle between a sound output direction of the first speaker and a sound output direction of the second speaker can be 0 degrees or more and 60 degrees or less, with respect to the driver seat.

According to one or more embodiments of the present disclosure, the vehicular apparatus can further comprise a dashboard disposed in front of the driver seat and a passenger seat parallel to the driver seat and including a driver seat region and a passenger seat region. The first speaker and the second speaker can be configured in the driver seat region.

According to one or more embodiments of the present disclosure, each of the first speaker and the second speaker can output a sound in a same direction. An angle between the driver seat and a sound output direction of each of the first speaker and the second speaker can be 30 degrees or more and less than 90 degrees.

According to one or more embodiments of the present disclosure, the driver seat region can comprise a first region corresponding to the front of the driver seat, a second region between the first region and a first side of the dashboard, and a third region between the first region and the passenger seat region. The first speaker and the second speaker can be configured in the first region or the third region.

According to one or more embodiments of the present disclosure, the vehicular apparatus can further comprise a third speaker at a periphery of a passenger seat parallel to the driver seat. The third speaker can be configured to output the first sound to the periphery of the passenger seat based on the first sound signal.

According to one or more embodiments of the present disclosure, the third speaker can comprise one or more sound apparatuses configured in a headrest of the passenger seat.

According to one or more embodiments of the present disclosure, the vehicular apparatus can further comprise a dashboard disposed in front of the driver seat and the passenger seat and including a driver seat region and a passenger seat region. The third speaker can be configured in the passenger seat region.

According to one or more embodiments of the present disclosure, the vehicular apparatus can further comprise a first rear passenger seat behind the driver seat, a second rear passenger seat behind a passenger seat parallel to the driver seat, a fourth speaker behind the first rear passenger seat, and a fifth speaker behind the second rear passenger seat. The fourth speaker can be configured to output the first sound to a periphery of the first rear passenger seat based on the first sound signal. The fifth speaker can be configured to output the first sound to a periphery of the second rear passenger seat based on the first sound signal.

According to one or more embodiments of the present disclosure, the vehicular apparatus can further comprise a sixth speaker configured in the first rear passenger seat, and a seventh speaker configured in the second rear passenger seat. The sixth speaker can be configured to output the second sound to the periphery of the first rear passenger seat based on the second sound signal. The seventh speaker can be configured to output the second sound to the periphery of the second rear passenger seat based on the second sound signal.

According to one or more embodiments of the present disclosure, the vehicular apparatus can further comprise a directional speaker at the periphery of the driver seat. The speaker driving circuit can be configured to generate a third sound signal based on navigation information. The directional speaker can be configured to output a directional sound to the periphery of the driver seat based on the third sound signal.

According to one or more embodiments of the present disclosure, the directional speaker can comprise a piezoelectric material.

According to one or more embodiments of the present disclosure, the directional speaker can be configured in a pillar interior material at a periphery of a driver seat window, or can be configured in a roof interior material on the driver seat.

According to one or more embodiments of the present disclosure, the third sound signal can comprise an amplitude-modulated ultrasound carrier signal.

According to one or more embodiments of the present disclosure, the vehicular apparatus can further comprise a display apparatus disposed in front of the driver seat and a passenger seat parallel to the driver seat and including a display part including a plurality of subpixels, and a control circuit configured to control the speaker driving circuit based on a viewing angle mode of the display apparatus. Each of the plurality of subpixels can be configured to switch to one of a first viewing angle mode having a wide viewing angle and a second viewing angle mode having a narrow viewing angle which is narrower than the wide viewing angle.

According to one or more embodiments of the present disclosure, each of the plurality of subpixels can comprise a first light emitting device, a second light emitting device, a pixel circuit configured to selectively allow the first light emitting device and the second light emitting device to emit light based on the viewing angle mode, a first lens overlapping the first light emitting device, and a second lens overlapping the second light emitting device.

According to one or more embodiments of the present disclosure, the first lens can have a semi-circular pillar shape. The second lens can be a semispherical lens.

According to one or more embodiments of the present disclosure, the display apparatus can comprise a first display part in front of the driver seat, a third display part in front of the passenger seat, and a second display part between the first display part and the third display part. The control circuit can be configured to control the speaker driving circuit to a first sound mode based on the first viewing angle mode of the plurality of subpixels in the second display part, and control the speaker driving circuit to a second sound mode based on the second viewing angle mode of the plurality of subpixels in the second display part.

According to one or more embodiments of the present disclosure, the control circuit can be configured to generate an image signal displayed on the second display part and a sound source signal corresponding to the image signal based on an image source. The speaker driving circuit can be configured to generate the first sound signal and the second sound signal based on the sound source signal.

According to one or more embodiments of the present disclosure, the speaker driving circuit can be configured to apply the first sound signal to the first speaker and the third speaker, based on the first sound mode or the second sound mode, or apply the second sound signal to the second speaker based on the second sound mode of the first sound mode and the second sound mode.

According to one or more embodiments of the present disclosure, the vehicular apparatus can further comprise a directional speaker at the periphery of the driver seat. The display apparatus can be configured to display an image corresponding to driving information on the second display part. The speaker driving circuit can be configured to generate a third sound signal based on the driving information. The directional speaker can be configured to output a directional sound to the periphery of the driver seat based on the third sound signal.

According to one or more embodiments of the present disclosure, the directional speaker can comprise a piezoelectric material.

According to one or more embodiments of the present disclosure, the speaker driving circuit can be configured to apply the first sound signal to the first speaker and the third speaker based on the first sound mode or the second sound mode, apply the second sound signal to the second speaker based on the second sound mode of the first sound mode and the second sound mode, and apply the third sound signal to the directional speaker based on the first sound mode or the second sound mode.

According to one or more embodiments of the present disclosure, the vehicular apparatus can further comprise a first rear passenger seat behind the driver seat, a second rear passenger seat behind the passenger seat, a fourth speaker behind the first rear passenger seat, and a fifth speaker behind the second rear passenger seat. The speaker driving circuit can be s configured to apply the first sound signal to the first, third, fourth and the fifth speakers based on the first sound mode or the second sound mode, and apply the second sound signal to the second speaker based on the second sound mode of the first sound mode and the second sound mode.

According to one or more embodiments of the present disclosure, the vehicular apparatus can further comprise a directional speaker at the periphery of the driver seat. The display apparatus can be configured to display an image corresponding to driving information on the second display part. The speaker driving circuit can be configured to generate a third sound signal based on the driving information. The directional speaker can be configured to output a directional sound to the periphery of the driver seat based on the third sound signal.

According to one or more embodiments of the present disclosure, the vehicular apparatus can further comprise a first rear passenger seat behind the driver seat, a second rear passenger seat behind the passenger seat, a fourth speaker behind the first rear passenger seat, and a fifth speaker behind the second rear passenger seat. The speaker driving circuit can be configured to apply the first sound signal to the first, third, fourth and the fifth speakers based on the first sound mode, and apply the first sound signal to only the third speaker and the second sound signal to the second speaker based on the second sound mode.

According to one or more embodiments of the present disclosure, the vehicular apparatus can further comprise a directional speaker at the periphery of the driver seat. The display apparatus can be configured to display an image corresponding to driving information on the second display part. The speaker driving circuit can be configured to generate a third sound signal based on the driving information. The directional speaker can be configured to output a directional sound to the periphery of the driver seat based on the third sound signal.

According to one or more embodiments of the present disclosure, the vehicular apparatus can further comprise a first rear passenger seat behind the driver seat, a second rear passenger seat behind the passenger seat, a third speaker behind the first rear passenger seat, a fourth speaker behind the second rear passenger seat, a fifth speaker configured in the first rear passenger seat, and a sixth speaker configured in the second rear passenger seat. The speaker driving circuit can be configured to apply the first sound signal to the first, third, and fourth speakers and the second speaker based on the first sound mode, and apply the second sound signal to one or more of the fifth speaker and the sixth speaker based on the second sound mode.

According to one or more embodiments of the present disclosure, the vehicular apparatus can further comprise one or more of a first auxiliary display apparatus at a rear surface of the driver seat and a second auxiliary display apparatus at a rear surface of the passenger seat.

According to one or more embodiments of the present disclosure, the vehicular apparatus can further comprise a directional speaker at the periphery of the driver seat. The display apparatus can be configured to display an image corresponding to driving information on the second display part. The speaker driving circuit can be configured to generate a third sound signal based on the driving information. The directional speaker can be configured to output a directional sound to the periphery of the driver seat based on the third sound signal.

It will be apparent to those skilled in the art that various modifications and variations can be made in the present disclosure without departing from the spirit or scope of the disclosures. Thus, it is intended that the present disclosure covers the modifications and variations of this disclosure provided that within the scope of the claims and their equivalents.

What is claimed is:

1. A vehicular apparatus comprising:
a first speaker configured to output a first sound to a periphery of a driver seat based on a first sound signal;
a second speaker configured to output a second sound to the periphery of the driver seat based on a second sound signal; and
a speaker driving circuit configured to generate the first sound signal and the second sound signal based on a sound source,
wherein the second sound signal has an anti-phase opposite to a phase of the first sound signal.

2. The vehicular apparatus of claim 1, wherein each of the first speaker and the second speaker comprises one or more sound apparatuses configured in a headrest of the driver seat.

3. The vehicular apparatus of claim 2, wherein the first speaker comprises a first sound apparatus at a first edge portion of the headrest and a second sound apparatus at a second edge portion of the headrest, and
wherein the second speaker comprises a first auxiliary sound apparatus at the first edge portion of the headrest and a second auxiliary sound apparatus at the second edge portion of the headrest.

4. The vehicular apparatus of claim 1, wherein an angle between a sound output direction of the first speaker and a sound output direction of the second speaker ranges from 0 degrees to 60 degrees, with respect to the driver seat.

5. The vehicular apparatus of claim 1, further comprising a dashboard disposed in front of the driver seat and a passenger seat substantially parallel to the driver seat,
wherein the dashboard includes a driver seat region and a passenger seat region, and
wherein the first speaker and the second speaker are configured in the driver seat region.

6. The vehicular apparatus of claim 5, wherein each of the first speaker and the second speaker outputs a sound in a same direction, and
wherein an angle between the driver seat and a sound output direction of each of at least one of the first speaker and the second speaker ranges from 30 degrees to less than 90 degrees.

7. The vehicular apparatus of claim 5, wherein the driver seat region of the dashboard comprises:
a first region corresponding to the front of the driver seat;
a second region between the first region and a first side of the dashboard; and
a third region between the first region and the passenger seat region, and
wherein the first speaker and the second speaker are configured in the first region or the third region.

8. The vehicular apparatus of claim 1, further comprising a third speaker at a periphery of a passenger seat disposed substantially parallel to the driver seat,
wherein the third speaker is configured to output the first sound to the periphery of the passenger seat based on the first sound signal.

9. The vehicular apparatus of claim 8, wherein the third speaker comprises one or more sound apparatuses configured in a headrest of the passenger seat.

10. The vehicular apparatus of claim 8, further comprising a dashboard disposed in front of the driver seat and the passenger seat,
wherein the dashboard includes a driver seat region and a passenger seat region, and
wherein the third speaker is configured in the passenger seat region.

11. The vehicular apparatus of claim 1, further comprising:
a first rear passenger seat behind the driver seat;
a second rear passenger seat behind a passenger seat disposed substantially parallel to the driver seat;
a fourth speaker behind the first rear passenger seat; and
a fifth speaker behind the second rear passenger seat,
wherein the fourth speaker is configured to output the first sound to a periphery of the first rear passenger seat based on the first sound signal, and
wherein the fifth speaker is configured to output the first sound to a periphery of the second rear passenger seat based on the first sound signal.

12. The vehicular apparatus of claim 11, further comprising a sixth speaker configured at a periphery of the first rear passenger seat; and
a seventh speaker configured at a periphery of the second rear passenger seat,
wherein the sixth speaker is configured to output the second sound to the periphery of the first rear passenger seat based on the second sound signal, and
wherein the seventh speaker is configured to output the second sound to the periphery of the second rear passenger seat based on the second sound signal.

13. The vehicular apparatus of claim 1, further comprising a directional speaker at the periphery of the driver seat,
wherein the speaker driving circuit is configured to generate a third sound signal based on navigation information, and
wherein the directional speaker is configured to output a directional sound to the periphery of the driver seat based on the third sound signal.

14. The vehicular apparatus of claim 13, wherein the directional speaker comprises a piezoelectric material.

15. The vehicular apparatus of claim 13, wherein the directional speaker is configured in a pillar interior material at a periphery of a driver seat window, or is configured in a roof interior material on the driver seat.

16. The vehicular apparatus of claim 13, wherein the third sound signal comprises an amplitude-modulated ultrasound carrier signal.

17. The vehicular apparatus of claim 1, further comprising:
a display apparatus disposed in front of the driver seat and a passenger seat adjacent to the driver seat, and including a display part including a plurality of subpixels; and
a control circuit configured to control the speaker driving circuit based on a viewing angle mode of the display apparatus,
wherein each of the plurality of subpixels is configured to switch to one of a first viewing angle mode having a wide viewing angle and a second viewing angle mode having a narrow viewing angle which is narrower than the wide viewing angle.

18. The vehicular apparatus of claim 17, wherein each of the plurality of subpixels comprises:
a first light emitting device;
a second light emitting device;
a pixel circuit configured to selectively allow the first light emitting device and the second light emitting device to emit light based on the viewing angle mode;
a first lens overlapping the first light emitting device; and
a second lens overlapping the second light emitting device.

19. The vehicular apparatus of claim 18, wherein the first lens has a semi-circular pillar shape, and
wherein the second lens is a semispherical lens.

20. The vehicular apparatus of claim 17, wherein the display apparatus comprises:
a first display part in front of the driver seat;
a second display part in front of the passenger seat; and
a third display part between the first display part and the second display part, and
wherein the control circuit is configured to control the speaker driving circuit to a first sound mode based on the first viewing angle mode of the plurality of subpixels in the second display part, and control the speaker driving circuit to a second sound mode based on the second viewing angle mode of the plurality of subpixels in the second display part.
